(19) United States
(12) Patent Application Publication
(10) Pub. No.: US 2009/0316719 A1
(43) Pub. Date: Dec. 24, 2009

(54) METHOD FOR MANAGING MECHANISMS TO ENHANCE TRANSMISSION OF DATA STREAMS IN A TUNNEL, CORRESPONDING COMPUTER PROGRAM PRODUCT, STORAGE MEDIUM AND TUNNEL END-POINT

(75) Inventors: Stephane Baron, Le Rheu (FR); Pascal Viger, Janze (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/419,962

(22) Filed: Apr. 7, 2009

(30) Foreign Application Priority Data
Apr. 8, 2008 (FR) 0852348

(51) Int. Cl. H04L 29/02

(52) U.S. Cl. 370/465

(57) ABSTRACT

A method is proposed for the management of mechanisms to enhance data stream transmission on a tunnel supported by a main communications network, the transmission of each stream being done according to a frame transport protocol with acknowledgment, the tunnel being implemented between first and second tunnel end-points connected respectively to first and second sub-networks, each stream being transmitted from a sender device to a receiver device through the tunnel, one of the devices which are the sender device and the receiver device being connected to the first sub-network and the other being connected to the second sub-network. The method comprises the following steps performed by the tunnel end-point for a given stream: first partial determining of a nature and a location of a problem of transmission for the given stream enabling first pieces of information to be obtained on a problem by analysis of the given stream; receiving second pieces of problem information coming from the second tunnel end-point and resulting from a second partial determining of the transmission problem performed by the second tunnel end-point; final determining of the nature and location of the transmission problem by combination of the first and second pieces of problem information; managing the transmission enhancement mechanisms as a function of the result of the final determining.

### 1. FIELD OF THE INVENTION

The field of the invention is that of communications networks.

More specifically, the invention relates to a technique for the management of mechanisms to enhance the transmission of data streams in a tunnel supported by a main communications network. The transmission of each stream is done according to a first protocol for the transportation of frames with acknowledgment (each frame, also called a data packet or datagram is associated with the sequence number), this first transport protocol being itself transported (or encapsulated) on the tunnel in a second transport protocol, with or without acknowledgment.

The democratization of high-bit-rate Internet on the one hand and the appearance of consumer audiovisual equipment having network connectivity on the other hand is going to create new forms of user behavior. These new forms of behavior will undoubtedly involve the emergence of individuals belonging to common-interest groups (i.e. common interests such as leisure, family, etc) that we might call “permanently linked” groups. These groups will set up almost permanent connections with other individuals of a same field of interest, setting up audio and/or video communications and sharing all kinds of information (audio, video, photo, text etc).

The technology of Virtual Private Networks (VPN) is offering a worthwhile solution to this demand. This technology enables real-time, transparent and secure communication) between individuals who share a same field of interest and at the same time use the Internet infrastructure which has low reliability but is inexpensive.

To communicate transparently and overcome the need for non-routable addresses, VPNs use a particular type of encapsulation known as tunneling which creates what is called a tunnel. This operation consists in encapsulating an A-level protocol (an embedded or conveyed or passenger protocol) in a B-level protocol (transport or conveying protocol) by means of an encapsulation protocol C. Thus, the transport protocol processes the passenger protocol as if it is were payload data.

FIG. 3, described in detail here below, presents an example of level-2 VPN, i.e. encapsulation in a level-2 tunnel (a level-2 tunnel means that the passenger protocol is a protocol of the layer 2 of the ISO model which describes the services offered by each of these layers and their interactions).

Tunneling can be used to transport a network protocol on a network that does not support it. It can also be used to provide different types of VPN functions such as for example private addressing.

Tunneling techniques are now increasingly used by functions entailing remote client access and home local area networks (LANs).

Here below in the description, we consider, by way of an example, solely level-2 or level-3 tunnels for which the level of the transport protocol B in the OSI model is equal to that of the transport layer (level-4 transport layer in the ISO model). It is clear that the context of the present invention is in no way exhaustive and that the level of the transport protocol B in the OSI model may be lower (in the case of a tunnel with Ethernet carrier) or higher (in the case of a time and with HTTP carrier).

Tunneling techniques are frequently used to interconnect two LANs in order to create a virtual private network (VPN) formed by the union of two original LANs. Secured VPNs include a cryptography and authentication algorithm to guarantee the secrecy of the transported data. A typical VPN configuration based on a tunneling technique is illustrated in FIG. 1 (described in detail here below). In this example, the tunnel end-points (TEPs) are not integrated into the gateways. The tunnel is set up between two tunnel end-points and each packet (also called a frame) sent to an apparatus connected to the remote LAN is encapsulated by the local tunnel end-point and then sent to the remote tunnel end-point which will de-encapsulate it and send it to the remote LAN. For the apparatuses, they are virtually connected to a same LAN. A communication between two apparatuses through the tunnel is called end-to-end communication.

VPNs are emerging today based on techniques involving multiple connections, i.e. with one tunnel formed by several carriers or channels. This technique enables the choice of a first transport protocol, for example for control data and a second transport protocol, for example for the payload data, both types of data going through the same tunnel end-point. There are many other possibilities as regards choice of the transport protocol for the passenger applications streams (for example depending on the priorities of the passenger streams etc). The term used then is “virtual channel” of a tunnel formed by numerous physical channels having their own transport protocols, it being known that only the tunnel end-point has knowledge of these physical channels. The choice of the transport protocol can therefore be optimized on each of the two channels.

In the prior art, it is chiefly the IP or Internet protocol (layer 3) or the TCP (transmission control protocol)/UDP (user datagram protocol) (layer 4) that is used. Since IP-based tunneling technologies cannot take account of the network address translation (NAT) mechanism and since they are not entirely compatible with the typical tunneling configuration of FIG. 1, the rest of the description here below considers (solely as examples) solutions based on the layer-4 (transport layer) i.e. on the TCP or the UDP.

As explained in the Appendix which presents the principles of operation of the TCP protocol, the TCP protocol (defined by the IETF standard RFC793) is an ARQ (Automatic Repeat Request or burst transmission protocol) type of protocol that is based on congestion control and retransmission mechanisms, and thus ensures delivery of each packet to its destination.

The UDP protocol is a far simpler and faster protocol that does not take account of the order of the frames and does not hamper acknowledgment.

As specified here above, the TCP protocol was designed to be flexible and work in a wide range of network communications environments including slow and fast links, with high latency, or links with variable error rates. Although the TCP protocol works for different environments, these performance levels (especially the bandwidth) are affected by the characteristics of each communications link used. The performance of the TCP protocol in terms of bandwidth suffers in environments that have lengthy routing times and/or possess a high error rate.

An advanced proxy concept (or PEP (proxy enhanced protocol)) type of concept based on the RFC 3135 standard can be used in infrastructures that suffer from characteristics specific to the communications links crossed. The RFC 3135 standard describes different types of mechanisms for the enhancement of data stream transmission (called PEP mechanism here below) embedded in network apparatuses on the routing path of a TCP stream between a server and a client. As shall be described here below, PEP systems are particularized for each environment in order to act on the control of TCP stream congestion accordingly.

In the case of the Internet, the connections are normally of the “best effort” type, i.e. these connections do everything possible to convey the information up to their destination but without guaranteeing a certain level of quality of service (QoS). Thus, in the context of VPN communications, the transport layer of the tunnel is subjected to high fluctuations in transmission capacity.

The passenger TCP streams of this tunnel classically perform an end-to-end congestion control, i.e. the two communications devices work together in the determining of the bit rate at which data must be send from the server device (also called a sender device here below) to the client device (also called a receiver device or sink device here below). Clearly, if the server device has wrong knowledge of the characteristics of the network, as in the case of a VPN for the transport section of the tunnel, it is likely to send too much data which will then be delayed or even lost in the tunnel.

PEP mechanisms can be set up in order to influence the congestion control for passenger TCP streams from the tunnel in accordance with the intrinsic limitations of this tunnel at a given point in time.

### 2. TECHNOLOGICAL BACKGROUND

The mechanisms for improving performance such as the PEP mechanisms are indispensable to optimum transmission on heterogeneous or non-reliable networks. However, their implementation calls for large quantities of resources in terms of both memory (because most of these mechanisms need to keep a local copy of the transmitted data for a certain period of time) and processor cycles.

Furthermore, there is a large number of different PEP mechanisms in the prior art each enabling an efficient response to a given problem. In networks transporting reliable protocols (that integrate retransmission mechanisms), the main issue at stake in terms of performance is that of properly managing retransmissions to prevent an increase in latency and a deterioration of the bit rate. Typically, certain PEP mechanisms have been designed to optimize retransmission due to losses on high-latency networks. Other PEP mechanisms for example are used to accelerate the retransmission due to losses on wireless networks.

In a non-reliable environment such as the internet, the prior art describes the use of PEP mechanisms for TCP streams. These mechanisms are set up in order to overcome a particular problem between the client and the TCP server. Since this problem is known in advance (it is a problem generally related to the architecture of the link), the PEP mechanism is parametrized and set up once and for all by an administrator.

An approach of this kind is described for example in the patent WO01/65805 (“Performance enhancing proxy and method for enhancing performance”). This patent document proposes the implementation of a battery of classic PEP mechanisms to enhance the performance of TCP sessions. The setting up of these PEP mechanisms is conditioned by user rules that enable the most efficient allocation of the resources necessary for the enhancement mechanisms. These PEP mechanisms include local data acknowledgment mechanisms (which require large buffer memories), path selection mechanisms or again TCP session multiplexing mechanisms. The selection of the TCP sessions to be enhanced is defined statically as a function of the “IP address/source or destination port” identification. Furthermore, the application of the PEP enhancement mechanisms is determined in advance and not adapted to modifications of the conditions of the network. This patent document describing a static and manual solution (entailing the start-up of the tunnel end-point on the basis of user preferences) does not allow the progress of transmission conditions on the network to be taken into account. As a consequence, the presence of the PEP mechanisms set up may, in certain cases, induce latency and unnecessary consumption of resources and possibly will not meet any new and initially unforeseen need to enhance transmission.

A known enhancement of this technique (described for example in the EP patent document EP 1 175042) adds a notion of profile which is exchanged between two proxies, in order to negotiate an application of the PEP mechanisms. However, once again, this profile is in no way influenced by the behavior of the network, each proxy receiving the profile from another (remote) proxy, this profile containing information on configuration of this other (remote) proxy.

However, none of the prior-art solutions mentioned here above is an optimal solution. Indeed, it can be understood that in order that the PEP mechanisms should be efficient, it is still necessary to know which ones to apply and for which traffic.

Ignorance of the real and precise cause of the problem may induce the use of the wrong type of PEP mechanisms. This may have an effect contrary to the one sought and may seriously lower performance. Furthermore, applying a PEP mechanism when it is not necessary involves an unnecessary consumption of resources which could be more useful if they were allocated to another task.

Furthermore, in the context of multiple transport VPNs (VPNs whose tunnel is borne by several channels simultaneously), this PEP mechanism selection task is made more complex because, for equivalent symptoms (in data retransmission), the causes may be different from that of a single-transport VPN, concerning especially the de-scheduling (i.e. the transmission of frames out of sequence.

### 3. GOALS OF THE INVENTION

The invention, in at least one embodiment, is aimed especially at overcoming these different drawbacks of the prior art.

More specifically, it is a goal of at least one embodiment of the invention to provide a technique for the management of mechanisms (PEP) for improving data stream transmission in a tunnel supported by a main communications network, said technique enabling optimum use of the resources of these mechanisms (especially in terms of memory but also in terms of processor cycles).

It is also an aim of at least one embodiment of the invention to provide a technique of this kind by which it is possible to take account of the specific nature of a multi-channel tunnel (i.e. a tunnel having several transmission channels, each stream of a frame being transmitted on one of these channels, according to a determined mechanism of allocation).

It is an additional goal of at least one embodiment of the invention to provide a technique of this kind that is simple to implement and costs little.

It is an additional goal of at least one embodiment of the invention to provide a technique of this kind that can be implemented automatically.

### 4. SUMMARY OF THE INVENTION

Method for managing mechanisms to enhance data stream transmission on a tunnel supported by a main communications network, the transmission of each stream being done according to a frame transport protocol with acknowledgment, said tunnel being implemented between first and second tunnel end-points connected respectively to first and second subnetworks, each stream being transmitted from a sender device to a receiver device through said tunnel, one of the devices which are said sender device and said receiver device being connected to the first sub-network and the other being connected to the second sub-network, said method comprising the following steps, performed by said first tunnel end-point, for a given stream (such as current stream):
a) a first partial determining step of determining a nature and a location of an issue of transmission (such as a problem of transmission) for said given stream, enabling to obtain first pieces of transmission issue information by analysis of said given stream;
b) a receiving step of receiving, from said second tunnel end-point, second pieces of transmission issue information resulting from the execution of a second partial determining of said transmission issue performed by said second tunnel end-point;
c) a managing step of managing said transmission enhancement mechanisms, as a function of said first and second pieces of transmission issue information.

Thus, in this particular embodiment, the invention relies on a wholly novel and inventive approach to the management of PEP mechanisms, based on cooperation between two tunnel end-points situated at the two ends of a same tunnel, to specifically and automatically determine the cause of the network disturbances (i.e. the nature and location of transmission problems) causing retransmission (including, as detailed here below, for a multi-channel tunnel). This determining operation subsequently enables the dynamic setting up of appropriate correction in using adapted PEP mechanisms, and in parametrizing them so that they take account only of problem-related traffic.

The setting up and dynamic parametrizing of the PEP mechanisms enables optimum use of the resources of these mechanisms, particularly in term of memory, but also in terms of processor cycles.

Furthermore, since the management of the PEP mechanisms is not centralized, it enables greater flexibility for setting up solutions to enhance performance. Indeed, said first tunnel end-point is free to set up any enhancement solution that it deems to be necessary (and which may be different from one tunnel end-point to another).

Furthermore, this approach is particularly advantageous in the case of “dynamic” tunnels, i.e. tunnels that are not open between two sites definitively (such as for example tunnels connecting two branches of a same firm). In this case, in an a priori parametrizing cannot be an optimal parametrizing.

Advantageously, said method further comprises the following step performed by said first tunnel end-point for said given stream:
transmitting said first pieces of transmission issue information (problem information) to said second tunnel end-point.

Thus, said second tunnel end-point can perform its own final determining of the nature and location of said transmission problem, and therefore decide to dynamically set up an appropriate correction on its side in using and parametrizing the appropriate PEP mechanisms.

Advantageously, if said given stream is a first stream coming out of said tunnel end-point and entering said tunnel, said first partial determining step comprises the following steps, for at least one frame transporting data of said given stream or an acknowledgment of data of said given stream:
the reading of a data sequence number or an acknowledgment sequence number contained in said frame:
obtaining the following comparison information:
   the data sequence numbers of the frames of said first stream already received from said first sub-stream by the first tunnel end-point and not yet acknowledged by a receiver device;
   last acknowledgment sequence number for said given stream received by said first tunnel end-point:
   number of times in which said last acknowledgment sequence number for said given stream has been received by said first tunnel end-point;
determining said first pieces of transmission issue information, on the basis of the data sequence number read or the acknowledgment sequence number read and said comparison information obtained.

Thus, for a stream coming out of the first tunnel end-point and entering the tunnel, the proposed solution can be implemented simply, automatically and inexpensively by relying on (small-sized) information such as the sequence number, relating to the data frames sent out by the tunnel end-point, for which the acknowledgment has not yet been received.

According to an advantageous characteristic, if said given stream is a first stream coming out of said first tunnel end-point and entering said tunnel, said first partial determining step comprises the following steps, performed in the event of a detection, from an acknowledgment sequence number received for said given stream, of a transmission issue located in the tunnel:
determining a type, reliable or non-reliable, of a channel via which the data to which said acknowledgment sequence number corresponds has been transmitted on the tunnel;
if said channel is of a reliable type, indicating that the nature of the transmission issue is “out-of-sequence frame transmission”;
if said channel is of a non-reliable type, indicating that the nature of the transmission issue is “loss of frame”.

Thus, for a stream coming out of the first tunnel end-point and entering the tunnel, the proposed solution takes account of the specific nature of a multi-channel tunnel having available a reliable channel, such as a channel using an acknowledgment transfer protocol and a non-reliable channel, and therefore enables the application of the PEP mechanisms specific to the disturbances generated by this type of tunnel. This solution is therefore highly advantageous for this type of tunnel.

Advantageously, if said given stream is a second stream coming out of said tunnel and entering said first tunnel end-point, said first partial determining step comprises the following steps, for at least one frame transporting data of said given stream or an acknowledgment of data of said given stream:
reading a data sequence number or of an acknowledgment sequence number contained in said frame;
obtaining the following pieces of comparison information;
   the data sequence numbers of the frames of said second stream already received from the tunnel by the first tunnel end-point and not yet acknowledged by a reception device;
   last acknowledgment sequence number for said given stream received by said first tunnel end-point;
   number of times said last acknowledgment sequence number for said given stream has been received by said first tunnel end-point;
determining said first pieces of issue information, from the data sequence number read or from said acknowledgment sequence number read and said pieces of comparison information obtained.

Thus, for a stream coming out of the tunnel and entering the first tunnel end-point, the proposed solution can be implemented simply, automatically and inexpensively by relying on (small-sized) information such as the sequence number, relating to the data frames sent out by the tunnel end-point, for which the acknowledgment has not yet been received.

Advantageously, if said given stream is a second stream coming out of said tunnel and entering said first tunnel end-point, said first partial determining step comprises the following steps, performed if an acknowledgment sequence number received for said given stream has already been received from the first sub-network by the first tunnel end-point and if the data required by a receiver having sent said acknowledgment sequence number has not yet been received by the first tunnel end-point:
indicating that the transmission issue (problem) is located in the tunnel or the second sub-network;
transmitting to the second tunnel end-point a control message requesting the second tunnel end-point to temporarily stop a mechanism of dynamic selection, for said given stream, of an effective channel amongst several transmission channels of said tunnel.

Thus, for a stream coming out of the tunnel and entering the first tunnel end-point, the proposed solution takes account of the specific nature of a multi-channel tunnel. Indeed, it can be used to “freeze” a channel selection mechanism implemented by the second tunnel end-point for the given stream in order to stabilize the transmission of this given stream and enable an effective determining of the nature of the transmission problem or problems (and therefore an optimum selection of the correction to be set up, in using adapted PEP mechanisms). This also enables the selection of a PEP mechanism on the basis of reliable information and statistics; indeed, should the PEP mechanism be set up only when a sufficient set of statistics has been acquired, showing that the detected problem is not isolated, the “freezing” of the selection mechanism facilitates the acquisition of these statistics and increases the reliability of these statistics.

According to an advantageous characteristic, said steps a) to c) are performed for each frame transporting data of said given stream or an acknowledgment of data of said given stream.

Thus, the determining of the nature and location of the transmission problems are optimized.

According to an advantageous characteristic, said first and second pieces of problem information comprise:
three pieces of information on the nature of the problem, pertaining respectively to the three following natures: “loss of frame”, “expiry of a transmission timer” and “out-of-sequence frame transmission”;
three pieces of information on the location of the problem, pertaining respectively to the following three locations: “on the first sub-network”, “on the second sub-network” and “on the tunnel”;
a piece of information on retransmission indicating that the data transmitted with said piece of retransmission information has already been transmitted on the tunnel.

This set of seven pieces of information (three on the nature of the problem, three on the location of the problem and one on retransmission) is simple to implement. At the same time it enables efficient selection from among a plurality of PEP mechanisms. It is clear however that the present invention can be implemented with a set of pieces of information comprising a different number of pieces of information and/or information of other types.

It must be noted that certain pieces of information of the set of information mentioned here above (for example the information on “expiry of a transmission timer” and the information on retransmission) can be used as intermediate information in the sense that it does not correspond to final information relating to the nature or location of a problem but is used to determine this final information.

Advantageously, said step of managing said transmission enhancement mechanisms comprises the following steps:
if said transmission issue for said given stream is totally determined and not yet processed, incrementing a counter associated with the type of said transmission issue for said given stream;
if said counter is higher than a pre-determined threshold, selecting a mechanism to enhance data stream transmission;
applying the selected enhancement mechanism to said given stream.

Thus, the proposed solution works according to a principle of accumulation so as to select and set up a PEP mechanism only beyond a determined threshold, for each type of transmission issue (transmission problem) that may be undergone by each stream. This optimizes the setting up and dynamic parametrizing of the PEP mechanisms.

Advantageously, said step of selecting a mechanism to enhance the data stream transmission is performed as a function of the nature and location of said transmission issue and as a function of the incoming or outgoing character of said given stream relative to the tunnel.

Thus, the selection of the PEP mechanisms is optimized.

Advantageously, said step of selecting a mechanism to enhance data stream transmission is such that:
a first enhancement mechanism, enabling the storage in a local buffer memory of the frames received by the first tunnel end-point and the retransmission of these frames when a loss is detected on the first sub-network, is selected if the nature of the transmission issue is a “loss of frames” localized in the first sub-network and if said given stream is a stream going out of said tunnel;
a second enhancement mechanism, used to delay the transmission to the sender device of acknowledgment frames received by the first tunnel end-point and coming from the first sub-network is selected if the nature of the transmission issue is an “out-of-sequence frame transmission” located in the tunnel and if said given stream is a stream entering said tunnel; and
a third enhancement mechanism to store the frames and if necessary re-order them before retransmitting them on the tunnel to the second tunnel end-point, is selected if the nature of the transmission issue is an “out-of-sequence frame transmission” located in the first sub-network and if said given stream is a stream entering said tunnel.

This example of a selection policy based on three PEP mechanisms is simple to implement. It is clear that other selection policies can be envisaged without departing from the context of the present invention.

In another embodiment, the invention pertains to a computer program product downloadable from a communications network and/or recorded on a computer-readable carrier and/or executable by a processor. This computer program product comprises program code instructions for the implementation of the above-mentioned method (in one of its different embodiments) when said program is executed on a computer.

In another embodiment, the invention relates to a storage medium, readable by a computer, storing a set of instructions that can be executed by said computer to implement a method for managing mechanisms enhancing data stream transmission via a tunnel, the transmission of each stream being performed according to a frame transport protocol with acknowledgment, said tunnel being implemented between a first and a second tunnel end-point connected respectively to a first and a second sub-network, each stream being transmitted from a sender device to a receiver device via said tunnel, one device among said sender device and said receiver device being connected to the first sub-network and the other being connected to the second sub-network, said set of instructions performing the following steps, for a given stream, when it is executed by said first tunnel end-point:
a) first partial determining step of determining a nature and a location of an issue of transmission for said given stream, enabling to obtain first pieces of transmission issue information by analysis of said given stream;
b) a receiving step of receiving, from said second tunnel end-point, second pieces of transmission issue information resulting from the execution of a second partial determining step of determining said transmission issue performed by said second tunnel end-point;
c) a managing step of managing said transmission enhancement mechanisms, as a function of said first and second pieces of transmission issue information.

In another particular embodiment of the invention, there is proposed a first tunnel end-point for managing mechanisms to enhance data stream transmission on a tunnel supported by a main communications network, the transmission of each stream being done according to a frame transport protocol with acknowledgment, said tunnel being implemented between first and second tunnel end-points connected respectively to first and second sub-networks, each stream being transmitted from a sender device to a receiver device through said tunnel, one of the devices which are said sender device and said receiver device being connected to the first sub-network and the other being connected to the second sub-network, said first tunnel end-point comprising, for a given stream (such as current stream).
means for partial determining, enabling the performance of a first partial determining of a nature and a location of an issue of transmission (such a problem of transmission) for said given stream, enabling to obtain first pieces of problem information by analysis of said given stream;
means for receiving, from said second tunnel end-point, second pieces of transmission issue information resulting from the execution of a second partial determining of said transmission issue performed by said second tunnel end-point;
means for managing said transmission enhancement mechanisms, as a function of said first and second pieces of transmission issue information.

More generally, the first tunnel end-point of the invention comprises means for implementing the above-mentioned method (in any of its different embodiments).

Advantageously, said first tunnel end-point further comprise means for transmitting said first pieces of transmission issue information to said second tunnel end-point.

Advantageously, said means for partial determining comprise the following means, activated for at least one frame transporting data of said given stream or an acknowledgment of data of said given stream, if said given stream is a first stream coming out of said tunnel end-point and entering said tunnel:
means for reading a data sequence number or an acknowledgment sequence number contained in said frame;
means for obtaining the following comparison information:
   the data sequence numbers of the frames of said first stream already received from said first sub-stream by the first tunnel end-point and not yet acknowledged by a receiver device;
   last acknowledgment sequence number for said given stream received by said first tunnel end-point;
   number of times said last acknowledgment sequence number for said given stream has been received by said first tunnel end-point;
means for determining said first pieces of transmission issue information, on the basis of the data sequence number read or the acknowledgment sequence number read and said obtained comparison information.

According to an advantageous characteristic, said means for partial determining comprise the following means, activated if said given stream is a first stream coming out of said first tunnel end-point and entering said tunnel, and in the event of a detection, from an acknowledgment sequence number received for said given stream, of a transmission issue located in the tunnel:
means for determining a type, whether reliable or non-reliable, of a channel via which the data to which said acknowledgment sequence number corresponds has been transmitted on the tunnel;
means, activated if said channel is of a reliable type, for indicating that the nature of the transmission issue is “out-of-sequence frame transmission”;
means, activated if said channel is of a non-reliable type, for indicating that the nature of the transmission issue is “loss of frame”.

Advantageously, said partial determining means comprises the following means, activated for at least one frame transporting data of said given stream or an acknowledgment of data of said given stream, if said given stream is a second stream coming out of said tunnel and entering said first tunnel end-point:
means for reading a data sequence number or of an acknowledgment sequence number contained in said frame;
means for obtaining the following pieces of comparison information;
   the data sequence numbers of the frames of said second stream already received from the tunnel by the first tunnel end-point and not yet acknowledged by a reception device;
   last acknowledgment sequence number for said given stream received by said first tunnel end-point;
   number of times said last acknowledgment sequence number for said given stream has been received by said first tunnel end-point;
means for determining said first pieces of issue information from the data sequence number read or from said acknowledgment sequence number read and said obtained pieces of comparison information.

Advantageously, said means for partial determining comprise the following means, activated if said given stream is a second stream coming out of said tunnel and entering said first tunnel end-point, if an acknowledgment sequence number received for said given stream has already been received from the first sub-network by the first tunnel end-point and if the data required by a receiver having sent said acknowledgment sequence number has not yet been received by the first tunnel end-point:
means for indicating that the transmission issue is located in the tunnel or the second subnetwork;
means for transmitting to the second tunnel end-point a control message requesting the second tunnel end-point to temporarily stop a mechanism of dynamic selection, for said given stream, of an effective channel amongst several transmission channels of said tunnel.

According to an advantageous characteristic, said first tunnel end-point comprises means for activating, for each frame transporting data of said given stream or an acknowledgment of data of said given stream, said means for partial determining, said means for receiving said second pieces of transmission issue information and said means for managing said transmission enhancement mechanisms.

According to an advantageous characteristic, said first and second pieces of issue information comprise:
three pieces of information on the nature of the transmission issue, pertaining respectively to the three following natures: “loss of frame”, “expiry of a transmission timer” and “out-of-sequence frame transmission”;
three pieces of information on the location of the transmission issue, pertaining respectively to the following three locations: “on the first sub-network”, “on the second sub-network” and “on the tunnel”;
a piece of information on retransmission indicating that the data transmitted with said piece of retransmission information has already been transmitted via the tunnel.

Advantageously, said means for managing said transmission enhancement mechanisms comprise:
means, activated if said transmission issue for said given stream is totally determined and not yet processed, for incrementing a counter associated with the type of said transmission issue for said given stream;
means for comparing an output value of said counter with a pre-determined threshold,
means, activated if said means for comparing indicate that the output value of said counter is higher than a pre-determined threshold, for selecting a mechanism to enhance data stream transmission;
means for applying the selected enhancement mechanism to said given stream.

Advantageously, said means for selecting a mechanism to enhance the data stream transmission take account of the nature and location of said transmission issueand the incoming or outgoing character of said given stream relative to the tunnel.

Advantageously, said means for selecting a mechanism to enhance data stream transmission are such that:
a first enhancement mechanism enabling the storage in a local buffer memory of the frames received by the first tunnel end-point and the retransmission of these frames when a loss is detected on the first sub-network, is selected if the nature of the transmission issue is a “loss of frames” localized in the first sub-network and if said given stream is a stream going out of said tunnel;
a second enhancement mechanism to delay the transmission to the sender device of acknowledgment frames received by the first tunnel end-point and coming from the first sub-network, is selected if the nature of the transmission issue is an “out-of-sequence frame transmission” located in the tunnel and if said given stream is a stream entering said tunnel; and
a third enhancement mechanism to store the frames and if necessary re-order them before retransmitting them on the tunnel to the second tunnel end-point, is selected if the nature of the transmission issue is an out-of-sequence frame transmission” located in the first sub-network and if said given stream is a stream entering said tunnel.

### 5 LIST OF FIGURES

Other features and advantages of embodiments of the invention shall appear from the following description, given by way of an indicative and non-exhaustive example (not all the embodiments of the invention are limited to the features and advantages of the embodiments described here below) and from the appended drawings, of which:

FIG. 1 illustrates a typical virtual private network (VPN) configuration using a tunnel;

FIG. 2 is an example of a classic layered model of a tunnel end-point in which the method of the invention can be implemented;

FIG. 3 is an example of a classic format of an Ethernet frame transporting a level 2 tunnel packet;

FIG. 4 is a flow chart of an algorithm for the management of a frame executed by a tunnel end-point according to a particular embodiment of a method of the invention;

FIG. 5 is a flow chart of an algorithm for the analysis of a LAN frame corresponding to a detailed view of the step 3 of FIG. 4;

FIG. 6 presents three data structures associated with the streams: a table (950) of the active streams at the tunnel end-point, a table (920) of the data maintained by a tunnel end-point for each active stream of the above-mentioned table (950) and a table (960) describing an information byte;

FIG. 7 is a flowchart of an algorithm for the analysis of the “data” part of a LAN frame corresponding to a detailed view of the step 31 of FIG. 5;

FIG. 8 is a flowchart of an algorithm for the analysis of the “acknowledgment” part of a LAN frame corresponding to a detailed view of the step 33 of FIG. 5;

FIG. 9 is a flowchart of an algorithm for the analysis of a tunnel frame corresponding to a detailed view of the step 4 of FIG. 4;

FIG. 10 is a flowchart of an algorithm for the analysis of the “acknowledgment” part of a LAN frame corresponding to a detailed view of the step 41 of FIG. 9;

FIG. 11 is a flowchart of an algorithm for the analysis of the “data” part of a tunnel frame corresponding to a detailed view of the step 43 of FIG. 9;

FIG. 12 shows two data tables used during the management of the take-over of streams by PEP mechanisms: a table (930) showing the number of errors per type of error for a given stream, and a generic table (940) of types of PEP mechanisms applicable as a function of the type and location of an error;

FIG. 13 shows two examples of specific tables for a first tunnel end-point corresponding to two implementations of the generic table (940) of FIG. 12 depending on whether the associated remote second tunnel end-point implements (table 9401) or does not implement (table 9402) the invention;

FIG. 14 is a flowchart of an algorithm for the management and parametrizing of the PEP mechanisms corresponding to a detailed view of the step 9 of FIG. 4; and

FIG. 15 shows the structure of a device (tunnel end-point) according to one particular embodiment of the invention.

### 6. DETAILED DESCRIPTION

In all the figures of the present document, the identical elements and steps are designated by a same numerical reference.

In the present description, the expressions “transmission problem” and “transmission error” are used in an equivalent sense (the “nature and location” of a problem and the “nature and location” of an error are therefore used in an equivalent sense).

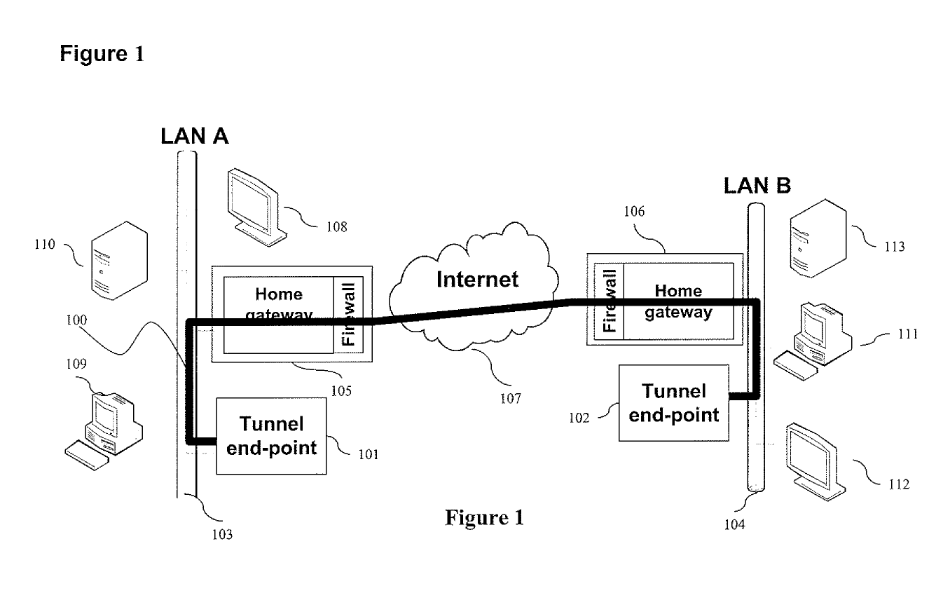

FIG. 1 illustrates a typical configuration of a virtual private network (VPN) implementing a tunnel 100 between a local tunnel end-point 101 and a remote tunnel end-point 102, through a communications network 107 (the Internet for example). This tunnel 100 connects two local networks: LAN A 103 and LAN B 104. Each of the LANs 103 and 104 has a high-bit-rate Internet access apparatus (a home gateway capable of integrating a firewall) 105 and 106, PC type apparatuses 109 and 111, servers 10 and 113 for the storage and distribution of the digital media (of the audio, video and photo type) as well as digital media rendering apparatuses 108 and 112. A tunnel end-point may be integrated into an audiovisual apparatus such as a digital television set. It can also be present in a PC type apparatus in the form of a program performing the functions associated with it.

Once the tunnel 100 is set up, the apparatuses 108, 109, and 110, connected to the LAN A 103, are capable of communicating with the apparatuses 111, 112 and 113, connected to the LAN B 104. For example, the customer 108 connected to the LAN A 103 can communicate with the server 113 connected to the network LAN B 104.

This FIG. 1 shows a simple communications network with only one tunnel, but it is understood that a same tunnel end-point may have to manage several tunnels (leading to an equivalent number of tunnel end-points) to interconnect a first LAN to several other LANs. Furthermore, for the sake of simplification, the figure does not show the infrastructure apparatuses in the Internet such as the Internet routers.

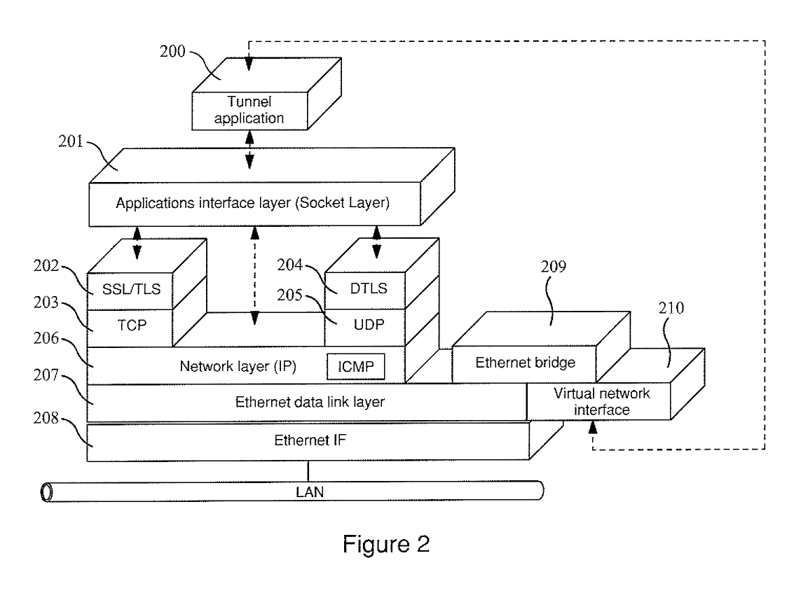

Referring to FIG. 2, we shall now describe the routing of an Ethernet frame that comes from one of the apparatuses 108, 109, 110 (connected to the LAN B 103) and will enter the tunnel 100. To this end, a layered model will be used. This layered model describes the protocol layers needed for the implementation of this tunnel 100. In this model, the protocol elements necessary for functions other than the use of the tunnel are not represented. For example, the protocol elements associated with an UPnP architecture, when a tunnel end-point 101 is integrated into a UPnP apparatus, are not shown.

The tunnel end-point 101 has a Ethernet physical interface 208 which hands over the Ethernet frames coming from one the apparatuses 108, 109, 110 to the link layer 207 for routing: this routing is done toward the network layer 206, for the Ethernet frames intended for the apparatus comprising the tunnel end-point or towards the bridge layer 209 for the other Ethernet frames. The bridge layer 209 carries out the classic operations of an Ethernet bridge such as the filtering of Ethernet frames and the relaying of these frames to the appropriate Ethernet output port or ports. The bridge has an Ethernet interface 207 and at least one virtual interface 210, simulating an Ethernet controller, attached to it. A virtual interface 210 is created for each tunnel instantiated by the application 200 to which it gives the Ethernet frames that must travel in transit on the respectively instantiated tunnels. Generally, the protocol of encapsulation of the tunnel represented by the application 200 performs the operations necessary for implementing each tunnel, among them especially the configuration, filtering and encapsulation (formation of a tunnel packet) and extraction of a frame.

The flames received from the virtual interface 210, after processing by the application 200, are handed over in the form of a packet through an applications interface or socket 201 to a reliable TCP transport protocol 203 or to an non-reliable UDP transport protocol 205, respectively secured by an SSL protocol 202 and a DTLS protocol 204.

The term “reliable transport mode” or “reliable transport protocol” is understood to mean a transport mode or protocol for which a device sending a frame or data packet obtains a piece of information on the delivery of the frame or data packet to a receiver device. The main characteristic of such a mode is the assurance of delivery of the frame or piece of data and not the latency of transfer between the sender device and the receiver device. Here below, the term “reliable channel” will be understood to mean a channel for the transportation of data of a tunnel between two sub-networks (also called LANs) using a data transport protocol (this data itself can take the form of packets or frames according to a determined transport protocol).

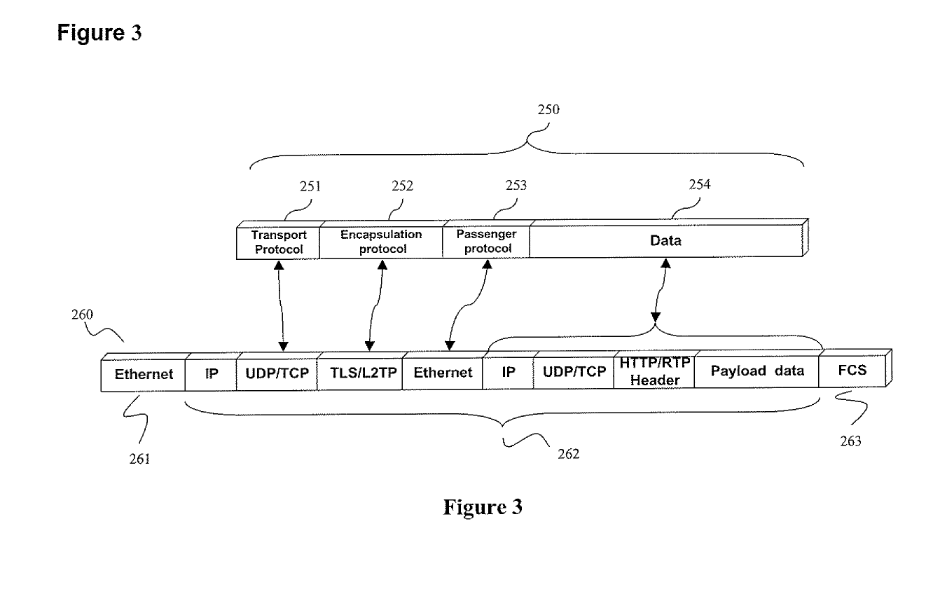

After processing by a transport protocol to form the tunnel packet 250 (FIG. 3), this packet is passed on to the network layer 206. The IP datagram thus formed with the current packet can now be transmitted on the LAN through the link layer 207 and the physical layer 208.

The reception of a frame coming from the tunnel 100 will follow a path in the tunnel end-point that is the reverse of the path presented here above.

FIG. 3 shows an example of a classic format of an Ethernet frame (reference 260) in transit for example on the LAN A 103 of FIG. 1 comprising:
an Ethernet header field (reference 261),
a first IP datagram (reference 262) itself transporting a level 2 tunnel packet (reference 250), and
an FCS (Frame Check Sequence) field (reference 263).

The tunnel packet 250 has four parts:
a transport protocol header field 251 (i.e. a TCP or UDP field in this example),
a header field of the encapsulation protocol 252 (i.e. L2TP or TTLS in this example, described especially in the following documents “IETF RFC3931, “Layer two tunneling protocol—version 3 (L2TPv3)”, J. Lau and all, March 2005>> and <<IETF RFC2246, “The TLS Protocol Version 1.0”>>),
a header field of the passenger protocol 253 (namely Ethernet in this example), and finally
a user data field 254 which itself comprises a second full IP datagram if no fragmentation has taken place in transit from the source apparatus.

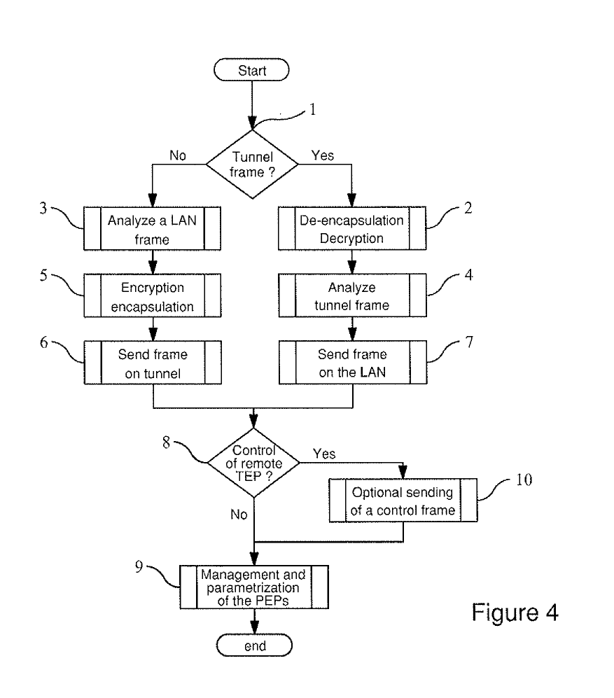

FIG. 4 presents an algorithm for the management of a frame according to a particular embodiment of the method of the invention executed by a tunnel end-point. This figure describes the processing of every frame entering the tunnel end-point (whether it comes from the tunnel or from the local area network (i.e. the LAN with which the tunnel end-point considered is connected)).

At the step 1, the method determines whether the frame comes from the LAN or from the tunnel.

If the frame comes from the LAN, it is a frame of the type referenced 250 in FIG. 3. It is therefore necessary initially to de-encapsulate the original frame (retrieve the passenger protocol 253 and its data 254). This de-encapsulation operation is performed during the step 2. During this step 2, if a data encipherment mechanism (such as the AES128 for example) has been set up, the frame is also deciphered. This step also enables the extraction of the information byte or bytes inserted during the performance of the step 5 by the remote tunnel end-point (see description further below this step 5). At the exit from the step 2, the retrieved frame is called a “tunnel frame”.

At the step 4, an analysis is made of the tunnel frame in order to ascertain that this tunnel frame represents a problem of transmission on the network and, if this is the case, it is sought to determine its cause. The invention takes account only of problems generating retransmission of frames in a transmission protocol incorporating a mechanism of data transmission in the event of loss (such as TCP for example). The term “cause of the problem” is understood to mean a twofold piece of information: firstly the nature of the problem (loss of frames transmission by frames off sequence, cutting off point to point communications between two pieces of equipment through a tunnel in three sectors: the tunnel 100 and the two LANs 103 and 104. For each tunnel end-point, the local LAN will be the LAN to which the tunnel end-point considered is connected, and the term remote LAN will be understood to mean the LAN situated at the other end of the tunnel.

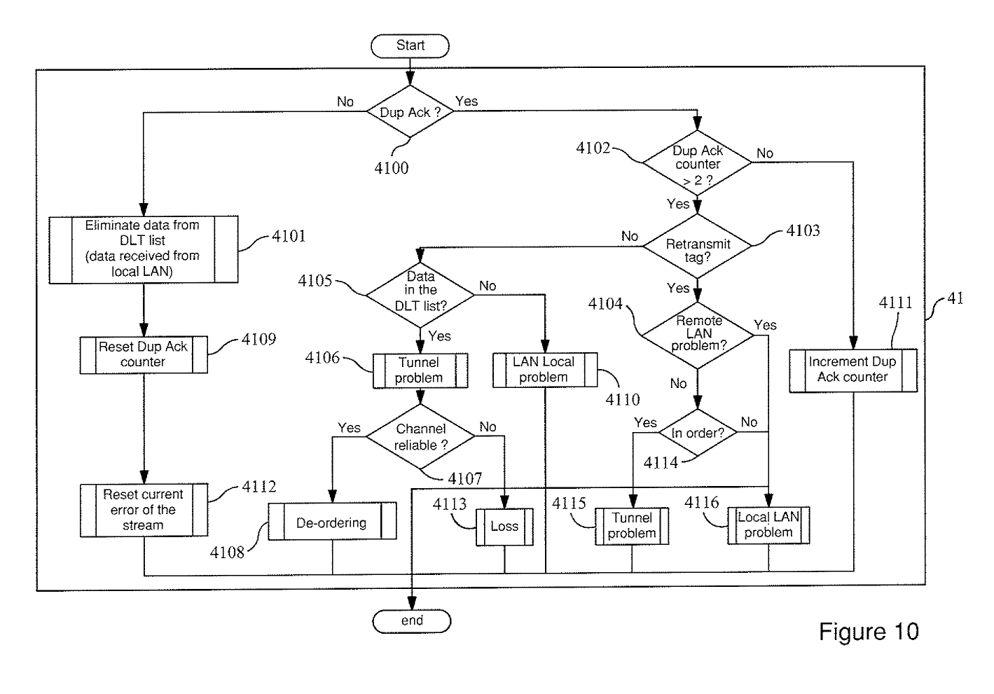

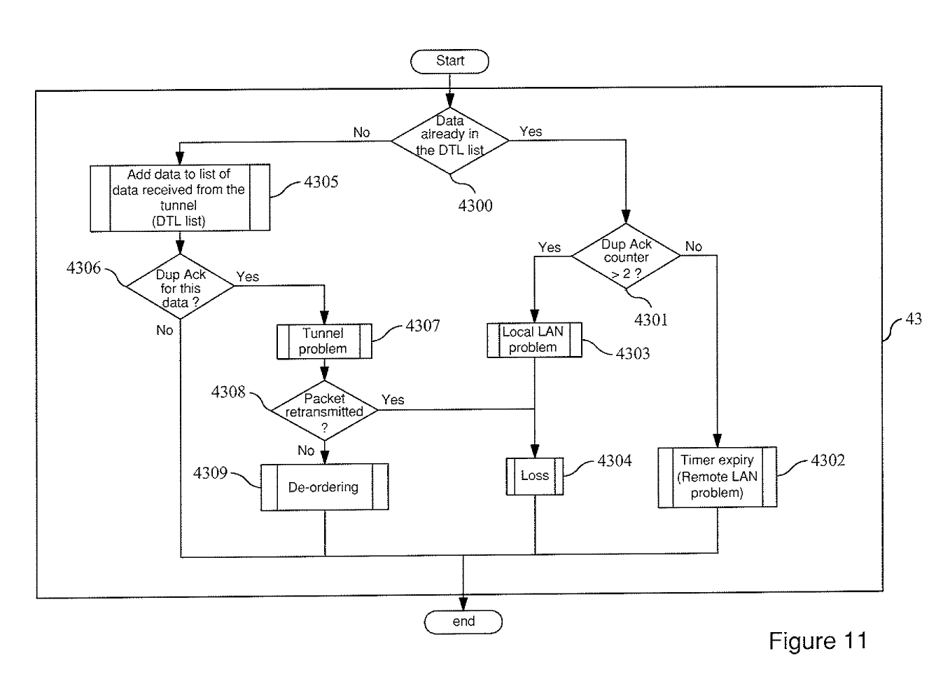

In the case of a two-way TCP session, one and the same tunnel frame can contain two parts containing information on two streams (each part undergoing an analysis made at the step 4 (see FIGS. 10 and 11 for further details)):
in an “acknowledgment” part information on a first stream going out of the tunnel end-point and entering the tunnel (here below called an incoming stream); and
in a “data” part, information on a second stream going out of the tunnel and entering the tunnel end-point (hereinafter called an outgoing stream).

The step 7 comprises the sending of the tunnel frame analyzed on the LAN.

Should the step 1 indicate that the operation is at the stage of processing a frame coming from the local LAN (in the present description a frame of this kind is called a LAN frame). Through the tunnel end-point, this LAN frame will cross the tunnel before it is sent again to the remote LAN. Before the frame is sent on the tunnel, the step 3 will analyze this LAN frame in order to ascertain that this LAN frame represents a problem of transmission (in the local LAN, the remote LAN or the tunnel section) and if this is the case, it will try to determine its nature and location.

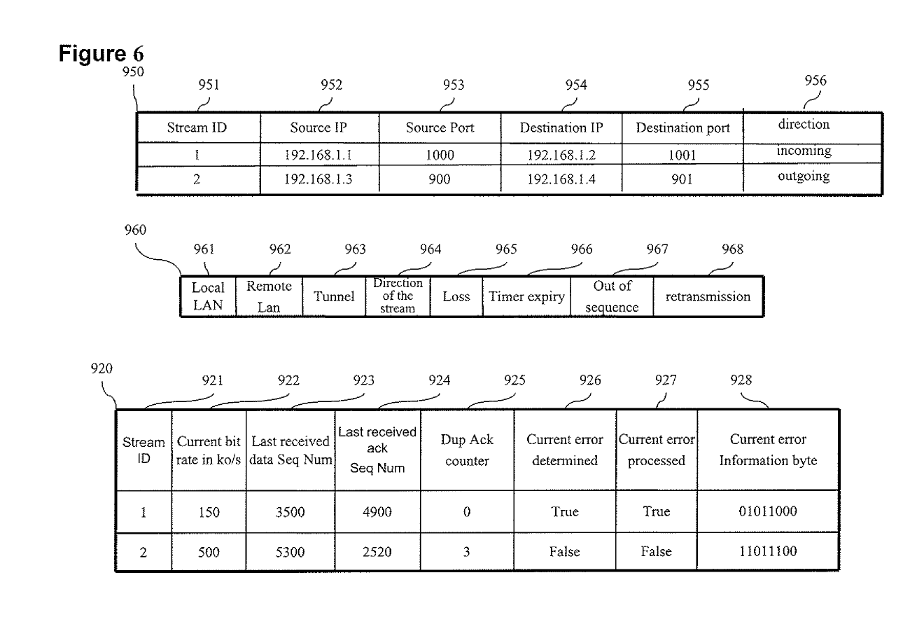

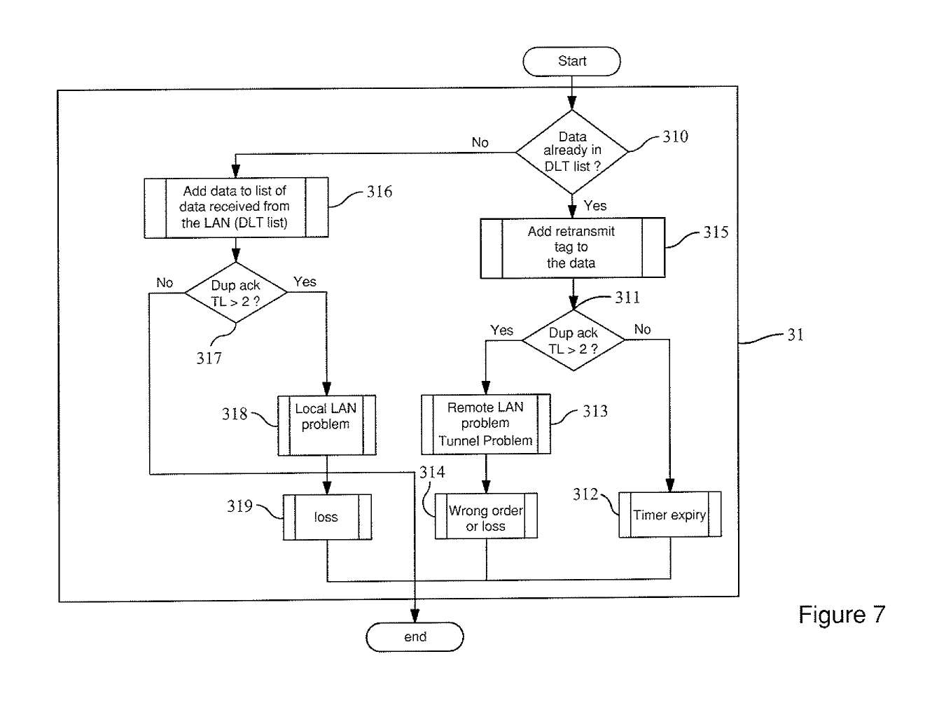

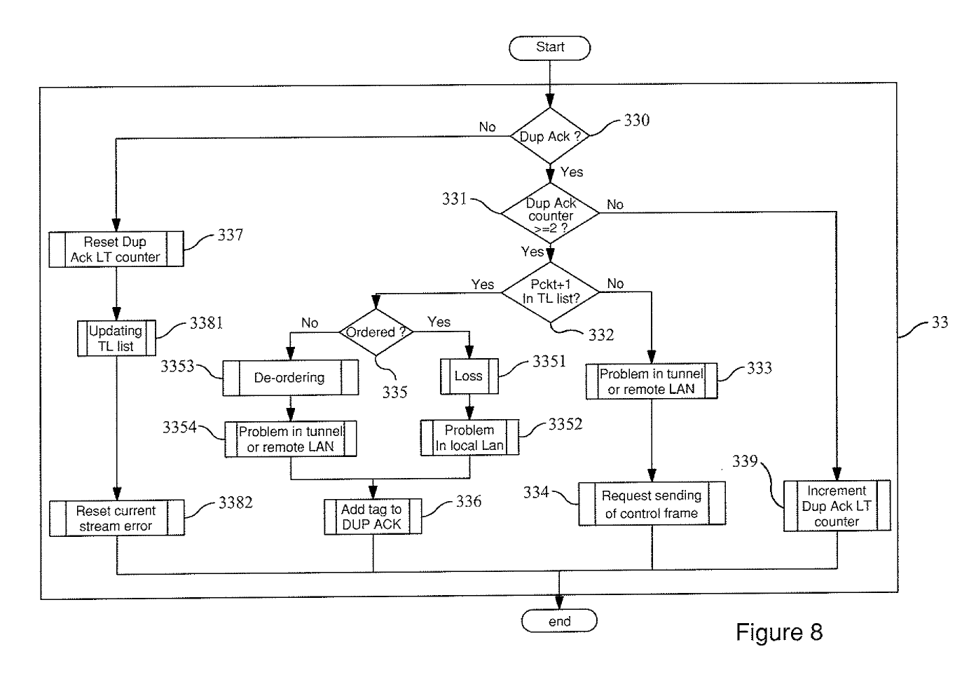

After the analysis phase 3, the step 5 will encapsulate and then encrypt, if necessary, the LAN frame in order to obtain a frame of the type referenced 250 in FIG. 3, the encapsulation protocol integrating the addition of the information byte or bytes 960 (see FIG. 6) representing the results of the analyses performed at the step 3. Indeed, should there be a two-way TCP session, one and the same LAN frame may contain two parts containing information on two streams (each part undergoing an analysis at the step 3 (see FIGS. 7 and 8 for further details)):
in a “data” part, information on a first stream going out of the tunnel end-point and entering the tunnel (here below called “incoming stream”); and
in an “acknowledgment” part, information on a second stream going out of the tunnel and entering the tunnel end-point (here below called “outgoing stream”).

The added information byte or bytes then enable the collaboration of the two tunnel end-points in order to refine the determining of the location and nature of the error.

The encapsulation frame 250 thus obtained will then be transmitted on the tunnel to another tunnel end-point in the step 6. The frame thus sent will be routed to the remote tunnel end-point by the “classic” mechanisms of IP networks.

At the step 6, when the LAN comprises a data segment, the channel on which this data segment will be transmitted is stored in a table called LTD (LAN-to-Tunnel Data). This LTD table will contain, for each data stream, all the data sequence numbers of the frames of data that have been received from the LAN by the tunnel end-point and have not yet been acknowledged by the receiver as well as an identifier of the channel in which the data frames have been transmitted (which may be a reliable or non-reliable type of channel).

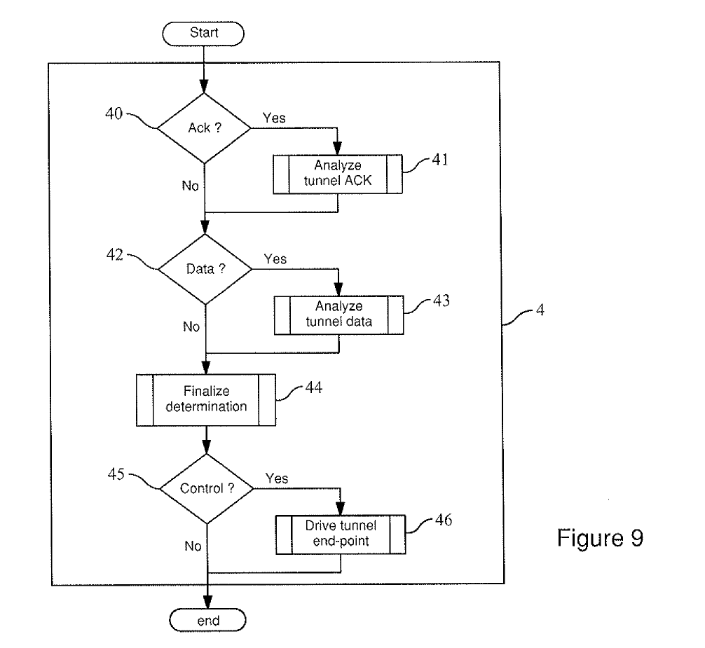

In the context of multi-channel type tunnels, uncertainties may appear during the analysis phase 3 or 4 (with respect to the cause of a network problem) related to the mode of transmission of certain data streams (for example when a data stream is in a transitional mode between a reliable channel and a non-reliable channel). A data stream can be transmitted in three modes: a reliable mode in which all the packets are transmitted on a reliable channel (channel with retransmission mechanisms), a non-reliable mode when the packets are transmitted on a non-reliable channel (channel without retransmission mechanisms) and a combined mode when certain packets of a stream are transmitted on a reliable channel, while others are transmitted on a non-reliable channel. The combined mode is generally “transitional”, i.e. it is temporary and it is set up only during the transition period between a reliable transmission mode and a non-reliable transmission mode and vice versa. When a tunnel end-point decides to change its mode of transmission, it cannot suddenly transmit all the packets of a stream according to the new mode of transmission without incurring serious problems of transmission (such as congestion, de-ordering of the packets etc). To prevent this, the tunnel end-point sets up a “transitional” mode during which an increasingly great fraction of the packets of a stream is transmitted according to the new mode of transport until the totality of the packets are transmitted according to the new mode. To remove this uncertainty, it may be advantageous to temporarily control the mode of transport of a stream (to “freeze” its progress for example). In the case of a stream consisting of data coming from the local LAN, this driving can be done directly by modifying the behavior of the local tunnel end-point. In the case of a stream coming from the remote LAN, the use of a communications protocol with the remote tunnel end-point is necessary. The step 8 determines whether the phase of analysis 3 or 4 has prepared a control frame to be sent to the remote tunnel end-point. If this is the case, the step 10 sends this control frame to the remote tunnel end-point. At the sending of the very first iteration of this step (which corresponds to the first frame managed by the tunnel end-point), a first control frame COM1 (described here below with reference to FIG. 9) is sent to the remote tunnel end-point in order to obtain information about its capacities (in terms of analysis and setting up of PEP). At the following iterations, a second control frame COM2 (described here below with reference to FIG. 9) is sent to the remote tunnel end-point.

Finally, during the step 9, depending on the result of the analysis 3 or 4, the invention will modify the parametrization of the PEP mechanisms of the local tunnel end-point in order to optimize their efficiency and their consumption of resources. In particular, this step 9 will enable the activation of the PEP mechanisms for the current stream if the analysis phase 3 or 4 shows it to be necessary, Furthermore, a check is made on the relevance of the maintaining of the PEP mechanisms previously activated by this same phase, enabling the PEP mechanism to be stopped for certain streams.

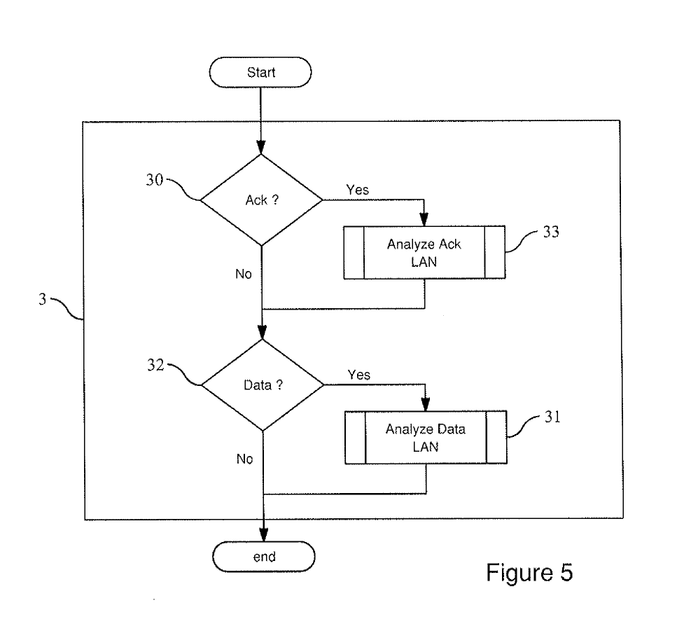

FIG. 5 shows an algorithm for the analysis of a LAN corresponding to a detailed view of the step 3 of FIG. 4.

At the step 30, a check is made to see if the LAN received is a TCP frame (this check is done by verifying the protocol field of the IP header), and whether it contains an acknowledgment (this may be done by looking at the value of the ACK bit of the TCP header). If the step 30 is positive, the acknowledgment sequence number present in the current LAN is analyzed during the step 33 (see FIG. 8).

The step 32 determines whether the current LAN is a TCP frame and contains data (present after the TCP header). If the step 32 is positive, the data sequence number present in the current LAN is analyzed at the step 31 (see FIG. 7). Referring now to FIG. 3, three structures of data associated with the pool is presented.

Referring now to FIG. 6, three data structures associated with the streams are presented.

Each data stream is characterized by its source IP address, its source TCP port as well as its destination IP address and its destination TCP port. It must be noted that a same TCP session can convey two data streams (one in each direction for the TCP communication is a two-way communication). The tunnel end-point detects the opening and closing of TCP sessions through the “three-way handshake” messages traveling between the customer on the LAN and the server on the other LAN (the customer sends a SYN frame to which the server responds by SYN ACK and finally the customer acknowledges the frame of the server through an ACK frame as described in the Appendix).

The table 950 is the table of the active streams on the tunnel header. The term “active stream” is understood here to mean a stream associated with a TCP session that is established and not closed. More specifically:
the field 951 represents a unique identifier assigned to each stream and serving as a reference for the other data structures pertaining to this stream;
the fields 952 and 953 respectively represent the IP source and destination addresses of the TCP session;
a the fields 954 and 955 respectively represent the source and destination ports of the TCP session for this stream;
the field 956 represents the direction of this stream (incoming or outgoing from the tunnel, according to the above definition).

The table 920 represents the data maintained for each active stream of the table 950. More specifically:
the field 921 represents the identifier of this stream (same identifier as the one referenced 951 in the table 950);
the field 922 represents the current mean bit rate of the stream (expressed in kilobytes);
the field 923 is the last (greatest) data sequence number received by the tunnel end-point for this stream;
the field 924 is the last acknowledgment sequence number received for this stream, i.e. the sequence number of the next data segment awaited by the receiver device (connected to the remote LAN) when this receiver has sent the acknowledgment;
the field 925 corresponds to the number of times in which the acknowledgment 924 has already been received from the receiver. When this counter is greater than 1, the term multiple acknowledgments or “Dup Ack” for duplicated acknowledgment is used. Here below, reference shall also be made to the counter 925 under the name “Dup Ack counter”;
the field 926 indicates whether the current error is determined (i.e. if the nature and location of this error are known without ambiguity);
the field 927 indicates whether the current error has already been taken into account for the management of the PEP mechanisms;
the field 928 is the information byte (960 type byte as detailed here below) associated with the current error.

The table 960 describes the meaning of the bits of a byte called an information byte. This byte is used to store information on location and nature for an error, for a given stream. The transmission of this byte from one tunnel end-point to the other plays a big role in the full determining of the nature and location of a problem. Each of fields 961 to 968 is a TRUE/FALSE type piece of information (typically 1 bit). More specifically:
the bits 961 to 963 indicate the possible location of the error (several bits may be simultaneously at TRUE when the location is not totally determined). The bits 961 to 963 respectively indicate whether the problem is located on the local LAN, the remote LAN or the tunnel section.
the bits 965 to 967 indicate the possible nature of the error (several bits may be at TRUE simultaneously when the nature is not totally determined). The bits 965 to 967 respectively indicate whether the problem is a loss, a TCP timer expiry or an out-of-sequence sending operation.
the bit 968 is used (when this byte is transmitted at the same time as the data segment to the remote tunnel end-point) to indicate that the transmission of this data segment is actually a retransmission.
the bit 964 indicates the sense of the stream and thus differentiates an information byte coming from the analysis of the “data” part of a LAN frame (step 31, FIG. 7) from an information byte coming from the analysis of the “acknowledgment” part of a LAN frame (step 33, FIG. 8). The bit 964 takes the value 0 in the former case and the value 1 in the latter case.

FIG. 7 is an algorithm for the analysis of the “data” part of a LAN frame corresponding to a detailed view of the step 31 of FIG. 5.

In this step 31, the sequence number of the data present in the current LAN frame is analyzed. This data sequence number is the number of the first byte of the data stream sent by the sender to the receiver (incoming stream in the tunnel). This data sequence number provides information on the part of the data transmitted in this LAN frame. By correlating this information with the acknowledgments received for this stream as well as with the chronology of the data already received, it is possible to deduce certain items of information on the network disturbances to which the data stream is subjected. For example, during a retransmission, it is possible to know whether the data has already effectively passed through the tunnel end-point or whether the loss has taken place upstream.

At this step 31, the invention uses the above-mentioned LTD table (it may be recalled that this table contains especially, for each data stream, all the sequence numbers of the data frames received by the LAN and transmitted by the tunnel end-point but not yet acknowledged by the receiver). The size of this table (or list) remains reasonable by construction because only four bytes (length of the sequence number) are kept for each non-acknowledged data frame. Furthermore, the quantity of non-acknowledged data is limited by the size of the reception window returned by the receiver.

The invention also uses the value of the field (924, FIG. 6) of the last acknowledged sequence number for the current stream (the stream to which the current frame belongs) as well as the value of the counter (925, FIG. 6) corresponding to the number of times in which the acknowledgment 924 has already been received from the receiver.

In the step 310, it is ascertained that the piece of data received has already been received by the tunnel end-point. To this end, a check is made to see whether the sequence number of the data is already present in the LTD table. In the event of a positive response at the step 310, the step 315 is executed. If not, the step 316 is executed.

At the step 315, the field 968 of the information byte of the current stream is positioned at TRUE, thus indicating that the data has already been transmitted. Since this byte is added to the frame before being sent on the tunnel, this information can be used by the remote tunnel end-point (see FIG. 11).

At the step 311, a check is made to see whether the current piece of data (already received) corresponds to the next piece of data awaited by the receiver for the current stream (field 924) and whether the counter of Dup Ack 925 of this stream is greater than 2 (which is interpreted as a request for retransmission by the TCP server).

Should the response to the step 311 be positive, it means that there is a retransmission of data by the TCP server following the reception of three identical acknowledgments for the same data frame (which can happen in the event of loss of a data frame or a sending of frames without order). The problem causing the retransmission is located on the tunnel or the remote LAN. The step 313 will therefore position the field 961 (local LAN) of the information byte 928 of this stream at FALSE. The step 314 positions the field 966 (timer expiry) of this very same information byte 928 at FALSE (thus indicating that the possibility has been ruled out).

Should the step 311 be negative, the step 312 positions the fields 965 and 967 of the byte 928 at FALSE because there is a timer expiry. However, since we have no indication about the location of the network slowdown, no field for locating the information byte 928 will be positioned.

At the end of the step 314 or the step 312, the retransmission field 968 is positioned at TRUE.

Should the step 310 return a FALSE value (the case of a piece of data received for the first time by the tunnel end-point), the step 316 is executed.

The step 316 adds the sequence number of the piece of data (sequence number field of the TCP header) to the LTD table.

The step 317 is identical to the step 311. It determines whether the current piece of data corresponds to the next piece of data expected by the receiver for the current stream (field 924) and whether the Dup Ack counter 925 of this stream is greater than 2. Should the result of the step 317 be positive, there is a loss on the local LAN. The step 318 will therefore position the fields 962 and 963 at FALSE to indicate a location on the local LAN (the field 961 being already positioned at TRUE during the re-initialization).

The step 319 positions the field 966 and 967 at FALSE to indicate that this is a loss (the field 961 being already positioned at TRUE during the re-initialization). Finally, since the error is completely determined, the step 319 also positions the field 926 at TRUE for the current stream.

FIG. 8 presents an algorithm for the analysis of the “acknowledgment” part of a LAN, corresponding to a detailed view of the step 33 of FIG. 5.

In this step 33, the acknowledgment sequence number present in the current LAN frame is analyzed. This acknowledgment sequence number is the number of the next byte of the data stream awaited by the receiver. This number acknowledges the correct reception of all the bytes preceding this number. By correlating this information with the acknowledgments received for this stream as well as with the chronology of the data already received, it is possible to deduce certain items of information on the network disturbances to which the data stream is subjected (stream going out of the tunnel).

At this step 33, the invention uses the a table (or list) called a TDL (Tunnel-to-LAN Data) table containing, for each data stream, all the sequence numbers of the data frames received from the tunnel by the tunnel end-point and not yet acknowledged by the receiver.

The invention also uses the value of the field (924, FIG. 6) of the last acknowledged sequence number for the current stream (the stream to which the current frame belongs) as well as the value of the Dup Ack counter (925, FIG. 6) corresponding to the number of times in which the acknowledgment 924 has already been received from the receiver.

The step 330 is used to determine whether the acknowledgment sequence number received corresponds to the one already received for this stream (field 924).

If this is not the case, then it is a new acknowledgment (this means that the piece of data received by the receiver is not erroneous, and that its sequence number corresponds to the first byte of the next expected piece of data). In this case, the step 337 positions the field 924 with the value of the current acknowledgment sequence number and positions the field 925 at 0 (indicating that this is the first reception).

At the step 3381, a search is made in the TDL table for the sequence number or numbers smaller than that of the field 924 and these numbers are eliminated from the table (the data having been correctly received).

At the step 3382, the information on the current error of the current stream is reset at 0 (fields 926 and 927 set at FALSE, and information byte set at 254:11111110 in binary notation).

Should the result of the step 330 be positive, the step 331 is executed.

The step 331 is used to determine whether the counter of Dup Ack 925 for this stream is greater than 2. If this is the case, the step 332 is executed. If not, the step 339 is executed.

At the step 339, the counter 925 is incremented by 1, thus indicating that the same acknowledgment has been received once more.

The step 332 is used to determine whether the piece of data required by the receiver (data whose data sequence number is equal to the acknowledgment number) has been received by the tunnel end-point. To this end, the step 332 makes a search in the TDL table to find out if the acknowledgment sequence number exists.

If the data has already been received from the tunnel (and therefore transmitted on the LAN), the step 332 is positive, and the step 335 is executed. If not, the step 333 is executed.

By an examination of the TDL table, it is determined in the step 335 whether the data has been received (in the right order), i.e. whether it has not been received after at least two frames having lower sequence numbers. This check makes it possible to know whether the current frame has undergone a de-ordering which could have caused the multiple acknowledgments “Dup Ack” received by the tunnel end-point from the LAN. If the data has been received in an ordered way, the “Dup Ack” messages can be the consequence only of a problem on the local LAN; however, since it is not possible to determine its nature, a loss (conservative mode) will be presumed. If the data has been received “out of order”, then it is a problem of a loss of order, but a problem that could have occurred in the tunnel or the remote LAN.

As a consequence, if the step 335 is positive, the step 3351 is executed. If not, the step 3353 is executed.

The step 3351 positions the fields 966 and 967 at FALSE, indicating that this is a loss (the field 965 being already positioned at TRUE during the resetting). Then, the step 3352 is executed.

The step 3352 positions the fields 962 and 963 at FALSE indicating that this is a problem that has occurred on the local LAN (the field 961 being already positioned at TRUE during the resetting).

Should the step 335 be negative (reception of the piece of data out of order), the step 3353 positions the fields 965 and 966 at FALSE, indicating that this is a change of order (the field 967 being already positioned at TRUE during the resetting), and then the step 3554 will be executed.

The step 3354 positions the field 961 at FALSE indicating that only the local LAN location has been ruled out.

At the end of the step 3354 or the step 3353, the step 336 is executed. The step 336 positions the field 968 of the information byte 960 at TRUE, thus indicating that the piece of data corresponding to the acknowledgment has already been received and that this is therefore not a problem of transmission on the tunnel.

Should the step 332 be negative, the step 333 positions the field 961 at FALSE indicating that only the local LAN location has been ruled out.

The step 334 constitutes a control frame COM2 to be sent to the remote tunnel end-point. This frame requests the remote tunnel end-point to “freeze” the mode of transport of the current stream (especially to keep the choice of the use of channels for the transport of this stream constant). This freezing will be removed when a corrective mechanism is set up for this stream (step 914). This freezing temporarily stabilizes the way in which a stream is managed so that the nature of an error can be accurately determined. Since this determining is done on a very small number of frames, the freezing period will not have any notable influence from the viewpoint of the sender and receiver apparatuses. If the freeze is not set up, the determining operation could be falsified because the invention works by an accumulation of clues on the nature and location of an error. Now, the mode of transport of a stream is taken into account (step 4107) when determining the nature of an error. A change in mode of transport during the determining operation may lead to a falsified analysis as can happen, for example, when the current mode of transport on the stream considered is a “combined” mode (i.e. a mode using both a reliable channel and non-reliable channel).

FIG. 9 is an algorithm for the analysis of a tunnel frame corresponding to a detailed view of the step 4 of FIG. 4.

During the step 40, a check is made to see whether the received frame is a TCP frame (in verifying the protocol field of the IP header) and whether it contains an acknowledgment (this may be done by looking at the value of the ACK bit of the TCP header). If the step 40 is positive, the acknowledgment sequence number present in the current frame is analyzed during the step 41.

In the step 42, a check is made to determine whether the current frame is a TCP frame and contains data (present after the TCP header). If the step 42 is positive, the sequence number of the data present in the current frame is analyzed during the step 43.

For each stream concerned by the current frame, the step 44 consolidates the result of the determining of the nature and location of the network problem by using:
a the information byte 960 present in the frame received from the tunnel (whose bit 964 corresponds to the current stream) (i.e. the information byte determined by the remote tunnel end-point), and
the information byte 960 determined by the tunnel header considered (i.e. the one that performs the present algorithm) for the current stream; this byte being stored in the column 928 of the table 920 of the information on the streams.

This consolidation is very simply done by permutating the values of the fields 961 and 962 of the byte 960 of the frame (the notion of the local LAN being relative to the tunnel end-point) and then performing a bit-to-bit logic AND operation between the information byte of the frame and the information bytes stored in the table 920 of the information on the streams. The result is stored in the information bytes stored in the table 920 (the previous piece of data is overwritten).

Through this operation, if a possibility has been ruled out during a phase of analysis on the remote tunnel end-point, it is also ruled out on the local tunnel end-point. The information on the location and nature are therefore enriched by information transmitted by the remote tunnel end-point. This collaboration between tunnel end-points thus removes ambiguity, especially as regards the location of the problem (indeed, it is often possible for a tunnel end-point to know if a problem has come from its local LAN or not but it is impossible for it to know only if the problem is located in the tunnel). Furthermore, the step 44 determines whether the error is totally determined (only one nature field at TRUE and only one location field at TRUE). If the error is totally determined, the step 44 positions the field 926 at TRUE.

The step 45 determines whether the current frame is a control frame specific to the communications protocol between the tunnel end-points.

If the step 45 is positive, the step 46 is executed. During the step 46, the tunnel end-point executes the commands present in the control frames sent by the remote tunnel end-point. These commands could indeed have an effect on the decision engine of the stream processing operations (the freezing the transitions of the streams in transition mode between transport on a reliable channel and non-reliable channel or vice versa). In a multi-channel tunnel there obligatorily exists a means to define the way in which a stream is conveyed on the tunnel (i.e. which tunnel is used to convey the stream). The way in which a stream is transported will here below be called: “stream transport mode”. In the case of a combined transport mode, the packets constituting a data stream are transmitted in using one among n channels, where two consecutive packets cannot be transmitted by the same channel. In this case, if one of the channels shows high disturbance, the determining of the nature of the error for a stream could be made difficult because the conditions will develop constantly for this stream depending on the channel used. Indeed, since the setting up of a PEP type correction mechanism is conditional on whether a threshold of the rate of errors of a given type is crossed, it is advantageous to be able to tell the tunnel end-point to modify the transport mode of a stream in order to enable a fine analysis of the problem.

In one embodiment of the invention, the following is the list of commands used:
COM1 command: presenting capacities of the tunnel end-point. This command enables a tunnel end-point to inform the remote tunnel end-point of its capacity to determine or not determine the nature and location of an error. This command includes the list of supported PEP mechanisms.
COM2 command: a request to modify the transport mode of a given stream. This command gives for a given stream (identified by its source and destination addresses as well as its source and destination ports) the desired transport mode (the following two modes are indispensable: stable, free). The stable mode, unlike the free mode, indicates that the tunnel end-point should not change the way in which a stream is carried (especially the channel used).

FIG. 10 presents an algorithm for analyzing the acknowledgment part of a tunnel flame corresponding to a detailed view of the step 41 of FIG. 9.

In the step 41, the acknowledgment sequence number present in the current frame coming from the remote tunnel end-point is analyzed. This sequence number is the data sequence number of the next byte of the data stream awaited by the receiver. This acknowledgment sequence number acknowledges the accurate reception of all the bytes preceding this number. By correlating this information with the acknowledgments received for this stream as well as with the chronology of the data already received, it is possible to deduce certain items of information therefrom on the network disturbances to which the data stream (incoming stream in the tunnel) have been subjected.

Furthermore, this frame has been “enriched” by the addition of the information byte 960 by the remote tunnel end-point (step 5, FIG. 4). This information byte 960 contains especially a field 968 indicating whether the data frame corresponding to the current acknowledgment has been received by the remote tunnel end-point (step 336). This information will be precious when determining the location of a problem on the tunnel.

During the step 4100, an operation is performed to determine whether the acknowledgment sequence number received corresponds to a multiple acknowledgment (“Dup Ack”). To this end, the acknowledgment sequence number of the frame is compared with the last acknowledgment sequence number received (field 924) of the current stream, If there is a multiple acknowledgment (“Dup Ack”), the step 4102 is executed. If not, the step 4101 is executed.

At the step 4101, the data sequence numbers smaller than the acknowledgment sequence number (corresponding to all the data acknowledged in the current acknowledgment) are eliminated from the TDL table of the data received from the local LAN and transmitted through the tunnel to the remote tunnel end-point.

The step 4109 resets the Dup Ack counter 925 at zero and positions the field 924 (sequence number of the next piece of data awaited with the acknowledgment value of the current frame).

The step 4112 resets the information on the current error of the current stream (fields 926 and 927 at FALSE and information byte at 254, i.e.: 11111110 in binary notation).

At the step 4102, the operation determines whether the Dup Ack counter 925 of the current stream is greater than 2 (retransmission). If this is not so, the step 4111 is executed. Otherwise, the step 4103 is executed.

At the step 4111, the Dup Ack counter 925 is incremented by 1 thus indicating that the current acknowledgment has been received once again.

The step 4103 is used to determine whether the field 968 of the information byte of the current frame indicates that the corresponding piece of data has been preliminarily received by the remote tunnel end-point.

If the result of the step 4103 is positive, we are in the presence of a problem of loss in the remote LAN or of a de-ordering, in the local LAN or the tunnel. The step 4104 is therefore executed to determine, from the information byte of the current frame, whether the problem has been diagnosed as a problem on the remote LAN (by the remote tunnel end-point).

If the step 4104 is negative (local problem or problem of the tunnel), the step 4114 is executed. If not, the step 41 is terminated.

The step 4114, through an examination of the LTD table, determines whether the data has been received (and therefore transmitted) “in order” i.e., that it has not been received after at least two frames of lower sequence numbers. This check makes it possible to know whether the current frame has undergone a de-ordering which could have caused multiple acknowledgments (“Dup Ack”) received by the tunnel end-point from the remote LAN. If the piece of data has been received in an ordered way, the multiple acknowledgments (“Dup Ack”) can be the consequence only of a problem occurring in the tunnel and the step 4415 is executed. If not, a problem has occurred on the local LAN and the step 4116 is executed.

The step 4115 therefore positions the fields 961 and 962 on FALSE to indicate a problem on the tunnel (the field 963 being already positioned at TRUE at the resetting).

The step 4116 positions the fields 962 and 963 on FALSE indicating a location on the local LAN (the field 961 being already positioned at TRUE during the resetting).

The step 4105 determines whether the next piece of data of the acknowledgment is already present in the LTD table. In other words, the operation determines whether the next piece of data awaited by the receiver has already been received by the local tunnel end-point.

If the result of the step 4105 is negative, the problem is located at the local LAN and the step 4110 positions the fields 962 and 963 on FALSE. If not, the step 4106 is executed.

If the result of the step 4105 is positive, this is the case of a piece of data transmitted by the local tunnel end-point (4105 TRUE) but not received by the remote tunnel end-point (4103 FALSE). There is therefore a problem in the tunnel. The step 4106 therefore positions the fields 961 and 962 on FALSE to indicate a problem on the tunnel. Then the step 4107 is executed.

The step 4107 determines whether the data corresponding to the current acknowledgment has already been transmitted to the remote tunnel end-point on a reliable channel. This step will therefore take account of the specific nature of the multi-channel type tunnels and distinguish between de-ordering and a loss.

If the step 4107 is positive, the piece of data is not lost but has simply undergone substantial de-ordering, certainly related to a transport mode (of the stream to which the piece of data belongs) which is a “combined” transport mode combining reliable transport and non-reliable transport. The step 4108 is therefore executed. If not, it is a loss and the step 4113 is executed.

The step 4108 positions the fields 965 and 956 of the information byte 928 on FALSE to indicate that the problem is of a de-ordering nature.

The step 4113 positions the fields 966 and 967 of the information byte 928 on FALSE to indicate that the problem is a loss.

FIG. 11 presents an algorithm for the analysis of the “data” part of a tunnel frame corresponding to a detailed view of the step 43 of FIG. 9.

At this step 43, an analysis is made of the sequence number of the data present in the current frame received from the remote tunnel end-point. This sequence number is the number of the first byte of the data stream sent from the sender to the receiver. This sequence number provides information on the portion of the data transmitted in this frame. By correlating this information with the acknowledgments received for this stream, as well as with the chronology of the data already received, it is possible to deduce certain items of information on network disturbance to which the data stream (the stream coming out of the tunnel) is subjected. For example, during a retransmission following a loss of data, it can be known if the data has effectively passed through the tunnel end-point or if the loss has taken place upstream.

Furthermore, this frame has been “enriched” by the addition of an information byte 960 by the remote tunnel end-point (step 5 of FIG. 4). In particular, at the step 43, the field 968 (positioned during the step 315 of FIG. 7) is used, indicating whether the current frame is a retransmission (from the viewpoint of the remote tunnel end-point).

At the step 4300, the operation determines whether the sequence number of the current data is already present in the TDL table of the data previously received from the tunnel. If the result of the step 4300 is positive, the step 4301 is executed. Otherwise the step 4305 is executed.

The step 4301 determines whether the data of the current frame corresponds to the next piece of data awaited by the receiver (field 924) and whether the Dup Ack counter (field 925) is greater than 2.

If the result of the step 4301 is positive, it means there is a loss of the current data on the local LAN. In this case, the step 4303 is executed.

The step 4303 positions the fields 962 and 963 on FALSE to indicate that this is a problem on the local LAN (since the field 961 is already positioned on TRUE at resetting).

If the result of the step 4301 is negative, the step 4302 is executed because we are in the presence of the expiry of the retransmission timer of the sender.

The step 4302 positions the fields 961 to 963 at FALSE for the information byte 928 to indicate that this is a problem on the remote LAN (the field 962 being already positioned at TRUE during the resetting). Furthermore, this step positions the fields 965 and 967 on FALSE to indicate that this is an expiry of timer (the field 966 being already positioned at TRUE at the time of resetting).

The step 4305 adds the sequence number of the new piece of data received to the TDL table.

The step 4306 determines whether the current piece of data corresponds to the next piece of data awaited by the receiver (field 924) and whether the Dup Ack counter (field 925) is greater than 2. If the result of the step 4306 is positive, it means there is a problem on the tunnel (data not yet received while other pieces of data, with higher sequence numbers, have already been received by the receiver) and the step 4307 is then executed. If not, the algorithm ends.

At the step 4307, the fields 961 and 962 of the byte 928 are positioned at FALSE to indicate a localized problem on the tunnel (the field 963 being already positioned at TRUE during the resetting).

The step 4308 determines whether the current piece of data is a retransmission or not. To this end, the field 968 of the information byte 960 (transmitted with the frame of the remote tunnel end-point) is examined. If the current packet is a retransmission, it means that the packet has been lost between the two tunnel end-points. The step 4304 is therefore executed, and the fields 966 and 967 are positioned at FALSE to indicate a loss (the field 965 being already positioned at TRUE during the resetting).

Should the step 4308 prove to be negative, the current piece of data is not a retransmission. It can therefore be deduced that this piece of data is simply out of sequence. In this case, the step 4309 is executed.

The step 4309 positions the fields 965 and 966 at FALSE to indicate a problem of de-ordering (the field 967 being already positioned at TRUE during the resetting).

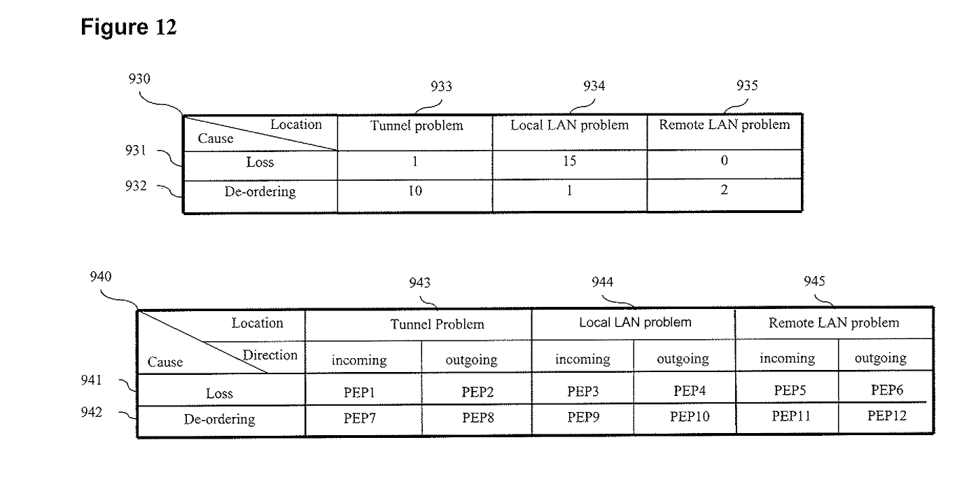

Referring now to FIG. 12, we present two data tables (930, 940) used during the management of the take-over of streams by the PEP mechanisms.

The table 930 contains the number of errors per type of error for a given stream. More specifically:
the line 931 corresponds to a loss;
the line 932 corresponds to an out-of-sequence transmission (also called de-ordering);
the column 933 corresponds to errors located in the tunnel;
the column 934 corresponds to areas located in the local LAN; and
the column 936 corresponds to areas located in the remote LAN.
   The table 940 describes the structure of the table of the types of PEP mechanisms applicable according to the type and location of an error. More specifically:
the row 941 corresponds to a loss;
the row 942 corresponds to an out-of-sequence transmission;
the column 943 corresponds to errors located in the tunnel;
the column 944 corresponds to areas located in the local LAN;
the column 945 corresponds to areas located in the remote LAN.

For each row 941, 942, the PEP mechanism to be set up may be different depending on the direction of the current stream (incoming or outgoing).

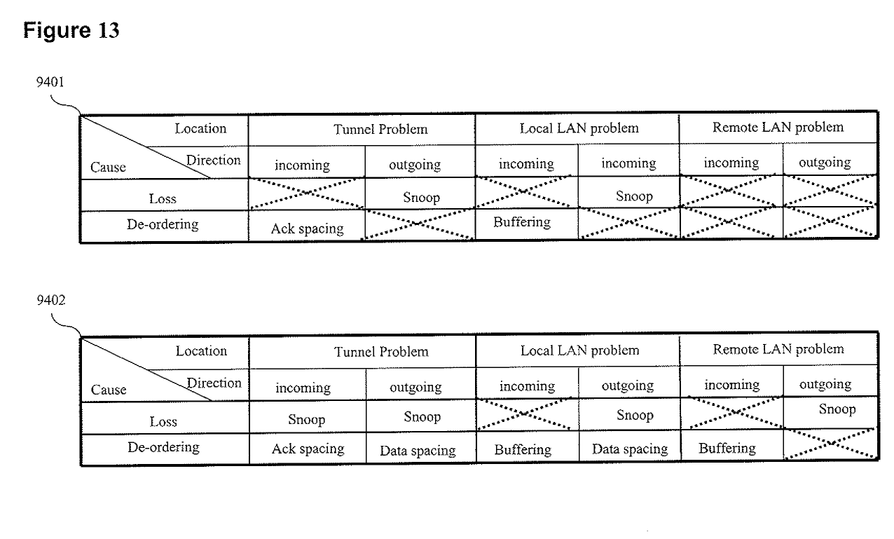

FIG. 13 presents two examples of a specific tables for a first tunnel end-point corresponding to two implementations of the generic table (940) of FIG. 12, depending on whether the associated second remote tunnel end-point implements (table 9401) or does not implement (table 9402) the invention.

The table 9401 describes an example of use of prior-art PEP mechanisms when the tunnel is open between two tunnel end-points implementing the invention (and using the same table). This table is only a typical example using certain prior-art PEP mechanisms but in no way excludes the use of any other PEP mechanism of an equivalent function enabling the correction of the types of problems described here. In this example, three types of PEP mechanism are used.

The “Snoop” PEP mechanism designates a PEP mechanism as described in the RFC3135 standard. This type of PEP mechanism stores frames received by the tunnel end-point in a local buffer memory, transmits them on the local LAN and retransmits when a loss is detected in the local LAN. The frames stored are destroyed upon reception of the corresponding acknowledgment (ACK), coming from the local LAN to which the tunnel end-point is connected. This technique generally used in wireless networks is advantageously placed in this system.

As for the “ACK spacing” PEP mechanism described in the RFC13135 standard, it delays transmission on the tunnel of the acknowledgment frames received by a tunnel end-point from the local LAN or vice versa. This technique applied here makes it possible for example to limit unnecessary retransmission during de-ordering problems.

The PEP buffering mechanism is a simple buffer storing the frames before retransmitting them (in re-ordering them if necessary) to the remote tunnel end-point. The size of the buffer memory per stream can be parametrized according to the scale of the de-ordering (typically five frames). This technique is not detrimental here because the additional transmission delay induced by the buffer memory is negligible relative to the RTT (Round Trip Time) of the WAN (several hundreds of milliseconds).

It can be noted that certain types of location and nature of errors are not processed in this example. Indeed, it is possible that there is no PEP mechanism adapted to the resolution of the problem or available on the tunnel end-point. For example, it is not possible to activate a PEP mechanism on a tunnel end-point making it possible to mitigate the loss of a packet occurring in the LAN to which it is connected, when this packet was intended for transmission on the tunnel. This is the case in the column “Pb local LAN” of the table 9401.

Furthermore, it can be seen that, in this example, the PEP mechanism is not set up in the case of localized problems on the remote LAN (indeed, it is better to set up mechanisms as close as possible to the location of the error). In this case, the remote tunnel end-point will activate a PEP mechanism adapted to resolving localized problems in the LAN to which it is connected.

Similarly, certain cases of problems located in the tunnel are left to the remote tunnel end-point. The tunnel end-points then cooperate with each other and a problem processed by one tunnel end-point by activation of a PEP mechanism will not have to be processed by the other tunnel end-point (there will be no activation of a PEP mechanism). This is the case in the “Pb tunnel” column of table 9401.

The table 9402 describes an example of use of PEP mechanisms when the remote tunnel end-point does not have the capacity to set up PEP mechanisms.

The PEP mechanisms used are the same as in the case of the table 9401 to which the data spacing PEP mechanism is added. This last-named PEP mechanism limits frame bursts that could cause a de-ordering storing the frames temporarily and sending them more regularly.

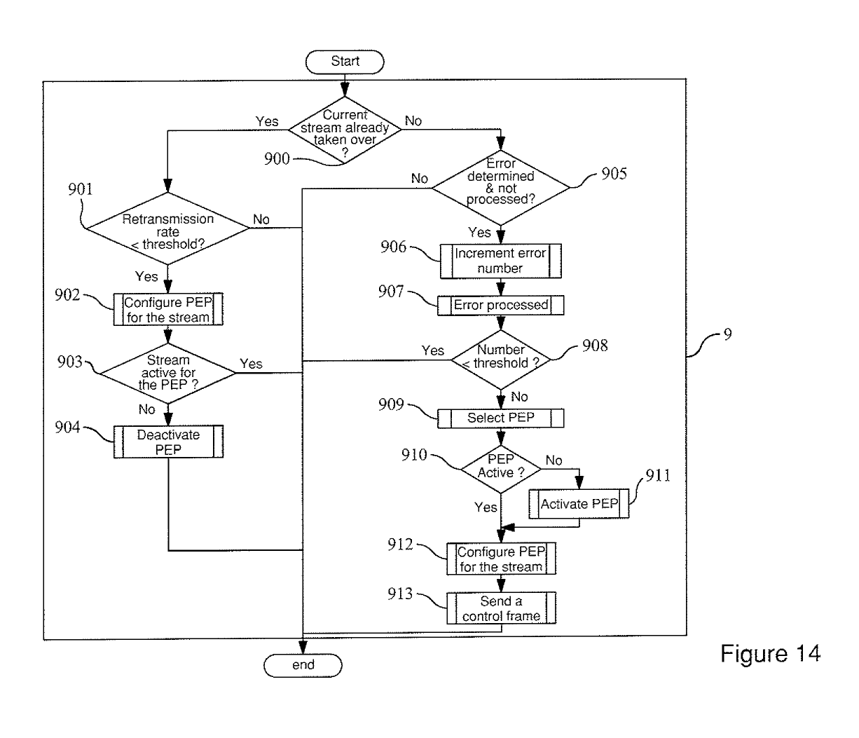

FIG. 14 presents an algorithm for the management and parametrizing of the PEP mechanisms corresponding to a detailed view of the step 9 of FIG. 4. This step 9 determines whether the take-over by the appropriate type of PEP mechanism should be activated or, on the contrary, deactivated.

The step 900 is used to determine whether the current stream is taken over by an active PEP mechanism. If this is the case, the step 901 is executed. If not, the step 905 is executed.

The step 901 examines the statistics of the PEP mechanism which takes charge of the stream and determines whether the rate of retransmission for this stream justifies the maintaining of the take-over of this stream. To this end, it determines whether this rate is below a predetermined threshold.

If the result of the step 901 is positive, the step 902 is executed.

At the step 902, the current stream is removed from the list of streams managed by the current PEP mechanism. The table 930 (FIG. 12) is also updated: the box in the table 930 corresponding to the nature and location of the current error is reset at zero.

The step 903 is used to determine whether the current PEP mechanism still possesses supervised streams. If this is not the case, the step 904 is executed.

The step 904 deactivates the current PEP mechanism.

If the result of the step 900 is negative, the invention determines whether the current stream should be taken over by a PEP mechanism.

The step 905 determines whether the current error is totally determined (field 926 at TRUE) and if it has not already been processed (step 927 at FALSE). If the result of the step 905 is positive, the step 906 is executed. At the step 906, the box of table 930 (FIG. 12) corresponding to the current error (nature and location) is incremented by 1.

At the step 907, the field 926 is positioned at TRUE to indicate that the current error has already been processed.

At the step 908, the invention determines whether the error number of a same nature and location as the current error is greater than a predetermined threshold.

If the result of the step 908 is positive, the take-over of the current stream by a PEP mechanism must be set up and the step 909 is executed.

At the step 909, the invention uses the table 940 (FIG. 12) to determine the PEP mechanism at which the take-over of the current stream must be activated.

At the step 910, the invention determines whether the PEP mechanism selected at the step 909 is active.

If the step 910 is negative, the step 911 is executed. If not, the step 912 is executed.

The step 911 activates the PEP mechanism.

The step 912 adds the current stream to the list of streams taken over by the current PEP mechanism.

Finally, the step 913 unfreezes the management of the mode of transport of the current stream at the level of the local tunnel end-point.

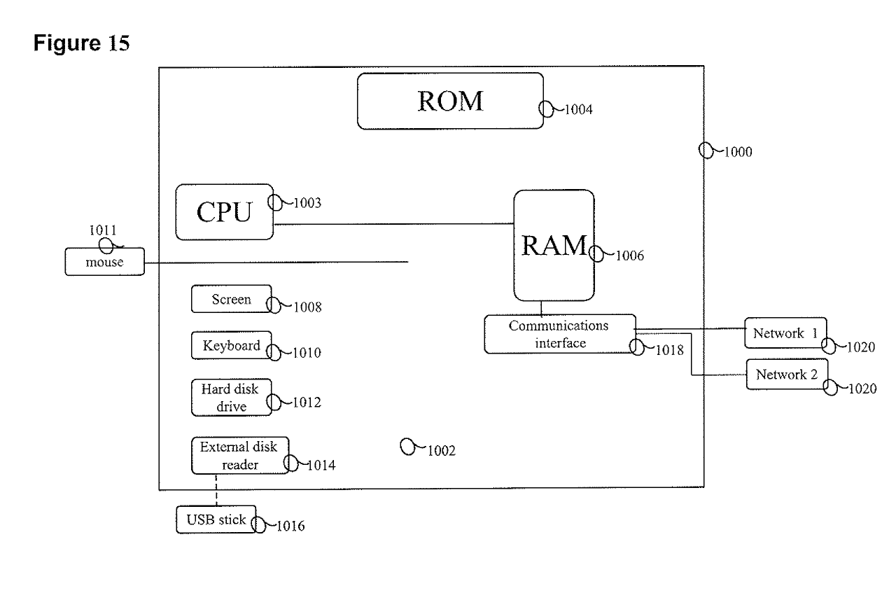

FIG. 15 illustrates a schematic configuration of a generic communications device 1000 adapted to implementing a particular embodiment of the technique of the invention. For example, the tunnel end-point 101 or 102 mentioned here above with reference to FIG. 1 is identical to the generic device 1000.

This generic device 1000 may be connected in particular to any means for the storage of images, videos or sound connected to a graphic card and delivering multimedia information to the generic device 1000.

The generic device 1000 has a communications bus 1002 to which the following are connected:
a central processing unit 1003 (for example a microprocessor referenced CPU);
a read-only memory 1004 referenced ROM capable of comprising the above-mentioned software program or programs;
a random-access memory 1006 (cache memory referenced RAM) comprising registers suited to recording variables and parameters created and modified in the course of execution by the above-mentioned software program or programs;
a communications interface 1018 linked to at least two distributed communications networks 1020, for example (in the case of FIG. 1) the LAN 103/104 and the Internet 107, the interface being capable of transmitting and receiving data with these networks.

The generic device 1000 also has (but this is optional):
a screen 1008 used to view the data and/or serve as a graphics interface with the network administrator who could interact with the programs according to the invention using a keyboard 1010 or any other means such as a pointing device, for example a mouse 1011 or an optical pencil;
a hard disk drive 1012 capable of comprising the above-mentioned programs;
an external disk drive 1014 enabling the reading of a USB memory stick.

The communications bus 1002 enables communications and interoperability between the different means included in the generic device 1000 or connected to this device. More generally, through the communications bus 1002, the central processing unit 1003 can communicate instructions to any device included in the generic device 1000 directly or by means of another generic device.

The executable code of each of program mentioned here above enabling the generic device 1000 to implement the method according to one embodiment of the invention (the method for the management of PEP mechanisms) can be stored in a non-volatile memory, for example the hard disk drive 1012, the read-only memory 1004 or the USB stick 1016.

The central processing unit 1003 controls and directs the execution of the instructions or portions of software code of the program or programs according to one embodiment of the invention (the method for the management of PEP mechanisms). When the equipment is powered on, the program or programs which are stored in the above-mentioned non-volatile memory (1012, 1004 or 1016) are transferred to the random-access memory 1006, which will then contain the executable code of the program or programs of the invention, as well as registers to memorize the variables and parameters needed to implement this embodiment of the method of the invention.

It must be noted that the communications apparatus comprising the device according to the invention can also be a programmed apparatus. This apparatus then contains the code of the computer program or programs, for example hard-wired into an applications specific integrated circuit (ASIC).

### Appendix

### Reminders Concerning the TCP Protocol

The TCP protocol (Transmission Control Protocol as defined by the RFC 793 standard) is an ARQ type protocol created in order to provide data transfer on the Internet according to a major criteria of speed and quality. At least two mechanisms are used to manage excess traffic arriving at a receiver: the first uses buffer reception memories and the second sets up a control of streams.

The TCP protocol is used to transfer data reliably although it uses the IP protocol which incorporates no control of datagram delivery. Indeed, the TCP protocol has a reception acknowledgment system also called an acknowledge system or ACK used by the client (also called client device or receiver machine) and the server (also called server device or sender machine) to make sure of the efficient mutual reception of data. When a data segment (also called a data packet) is sent, an order number (or called a sequence number) is associated therewith. Upon reception of a data segment, the receiver machine will return a data segment whose flag ACK is at 1 (in order to report that this is an acknowledgment of reception) accompanied by an acknowledgment of reception number equal to the previous order number. Since the communications process, which is carried out by means of a data transmission and reception acknowledgment, is based on an order number (or sequence number) the sender and receiver (server and customer respectively) machines must know the initial order number of the other machine (called initial sequence number or ISN).

A TCP connection is set up in three stages:

in a first stage, the client sends a data segment comprising the SYN flag (or SYN message) to report that this is a synchronization segment with its initial sequence number (ISN=x);
in a second stage, the server receives the synchronization segment coming from the client then sends it an acknowledgment of reception, i.e. a data segment whose flag ACK is at 1 and whose flag SYN is at 1 comprising its own sequence number (ISN=y), but it must also acknowledge the previous packet, which it does with an acknowledgment of reception number that contains the initial order number of the client incremented by 1 (ack=x+1);
in a third stage, the client sends the server an acknowledgment of reception, i.e. a segment whose flag ACK is at 1, whose flag SYN is at 0 because it is no longer a synchronization segment. Its order number is incremented (seq=x+1) and the acknowledgment reception number represents the initial order number of the server incremented by 1 (ack=y+1).

Once this phase called a “three-way handshake” is completed, the two applications are capable of exchanging the bytes that warrant the setting up of the connection.

The stream control manages the allocation of resources, such as the memory and the process. at the level of the intended recipient In general, in compliance with stream control, the destination sets a limit on the transmission throughput rate implemented by all the sources that send data to the destination. The sources and the intended recipients coordinate the transfer of data through an exchange of messages comprising queries and acknowledgments of reception. Before the source starts sending packets, it sends a request to the destination aimed at obtaining permission to start transmission. In response to this query, the intended recipient sends a message comprising an identification of the number of packets that the source can transmit to the intended recipient without additional authorization. This number is commonly called “window size”. Then, the source sends the number of authorized packets to the intended recipient and waits for the intended recipient to verify their reception. After the intended recipient has successfully received a packet, it sends a return message to the source comprising an acknowledgment of reception (acknowledgment) indicating that the packet has been received successfully and in certain cases permitting the source to send another packet. Thus, the number of packets on the network traveling from the source to the intended recipient never exceeds the authorized window size.

Here below, different names for the TCP windows shall be noted:

TCP window: the initial value validated during the setting up of the connection, which is a maximum value permitted throughout the duration of the connection;

congestion window (CWND): the value of the current window sent from the server in a TCP packet addressed to the client;

acknowledgment window (acknowledge-window or advertise-window): the value of the window sent in an ACK TCP packet to the server which indicates the memory occupation in the client;

sliding window: the value of a window internal to a server enabling it to know the number of pieces of data to be transmitted since the arrival of the last acknowledgment TCP segment.

A large TCP window size encourages sending. If the number of pieces of data received is greater than what the window indicates, the out-of-window data are rejected. This loss leads to a large number of retransmissions and unnecessarily overburdens the network and the TCP. The use of a small size of window breaks up the throughput rate by adding a certain additional delay to the loop time or RTT but does so in limiting the excess load of the network due to retransmission. The opening of a very small window also reduces performance by increasing the weight of the headers relative to the data.

Even with the setting up of these mechanisms, in a busy network, several sources simultaneously send streams in the network to more than one destination. If too many such streams converge on a single router in a very short period of time, then the limited capacity in buffer memory of this router makes this volume of stream incapable of being processed, and this router will reject or destroy a part of the packet. When such a situation occurs, the network is said to be congested. When such a situation occurs, the transfers in the network get slowed down considerably and the throughput rate of the network drops. Since certain resources of the network are dedicated to the retransmission, when the network undergoes an overload, there is a substantial risk of occurrences of propagation of congestions and of the blocking of the entire network.

The value of the TCP MSS (Maximum Segment Size) field indicates the maximum quantity of TCP data per IP datagram that the local system can accept. When sent, the IP datagram can be broken up into several packets. In theory, this value can reach the value 65495, however a value of this size is never implemented. Typically, a terminal system uses the MTU interface (outgoing interface Maximum Transfer Unit) from which the value 40 is deducted as its TCP MSS field value. For example, a TCP MSS field value for the Ethernet protocol is 1460 (1500−40=1460).

The value of the TCP MSS field is entered into the packets serving to set up the connection which are the packets containing the signal SYN. Each side sends its own TCP MSS field value. It is not required that each side should use the same TCP MSS field value but each side cannot send more data than what is authorized by the remote station. The value of the TOP MSS field is sent at the maximum segment size (MSS) of the TCP header option.

It will be noted that the default value of the size of the buffer memory of the connection interface differs greatly as a function of implementation. The former implementations derived from Berkeley dictates default values of the TCP reception and sending buffer memories at 4 Kb, while the more recent system implements greater values (for example up to 64 Kb). For example, in Windows XP (registered mark), the current value of the window size at reception adjusts automatically according to pair increments of the maximum segment size (MSS) negotiated when the TCP connection was set up.

The TCP protocol uses several algorithms to manage its congestion, more particularly a slow start and a congestion avoidance algorithm. Each of these algorithms manages the sending throughput rate of the server by manipulating a congestion window (CWND) which restricts the number of unacknowledged bytes in transit at a given point in time. The possible TCP throughput rate for a given congestion window value is determined by the speed at which acknowledgments are received. The time taken to receive an acknowledgment after the sending of a piece of data is called TCP round-trip time (RTT).

When a connection is started up, the slow start algorithm is set up to rapidly increase the congestion window (CWND) in order to attain the value of the bandwidth as quickly as possible. The variable SSTHRESH (steady-state threshold) is maintained by the server in order to distinguish the two phases. When the sender concludes that there is a loss of a segment, it processes this information as an implicit signal of a network overload and rapidly decreases the congestion window. After having deduced the congestion threshold SSTHRESH approximately, TCP sets up the congestion avoidance algorithm which increases the value of the congestion window more slowly in order to occupy the additional available bandwidth.

During the slow start phase (when starting the connection or after the time-out has been exceeded), the starter starts with a CWND window setting operation of 1 MSS, and CWND increases by 1*MSS after each reception of a acknowledgment. The congestion window CWND is approximately doubled at each RTT (exponential growth). During the congestion avoidance phase (congestion-avoidance) the increase in CWND is limited to 1*MSS by RTT (additive growth).

A drop in performance is noted, in the Internet network where one can note a long propagation time. This prevents the transmission window from sending new segments rapidly (the acknowledgments determine the increase in the transmission window and the arrival after a long period of time).

What is claimed is:

1. Method for managing mechanisms enhancing data stream transmission via a tunnel, the transmission of each stream being performed according to a frame transport protocol with acknowledgment, said tunnel being implemented between a first and a second tunnel end-point connected respectively to a first and a second sub-network, each stream being transmitted from a sender device to a receiver device via said tunnel, one device among said sender device and said receiver device being connected to the first sub-network and the other being connected to the second sub-network,
wherein it comprises the following steps performed, for a given stream, by said first tunnel end-point:
a) a first partial determining step of determining a nature and a location of an issue of transmission for said given stream, enabling to obtain first pieces of transmission issue information by analysis of said given stream;
b) a receiving step of receiving, from said second tunnel end-point, second pieces of transmission issue information resulting from the execution of a second partial determining step of determining said transmission issue performed by said second tunnel end-point;
c) a managing step of managing said transmission enhancement mechanisms, as a function of said first and second pieces of transmission issue information.

2. Method according to claim 1, wherein it further comprises the following step, performed by said first tunnel end-point for said given stream:
transmitting said first pieces of transmission issue information to said second tunnel end-point.

3. Method according to claim 1, wherein, if said given stream is a first stream coming out of said tunnel end-point and entering said tunnel, said first partial determining step comprises the following steps, for at least one frame transporting data of said given stream or an acknowledgment of data of said given stream:
reading a data sequence number or an acknowledgment sequence number contained in said frame;
obtaining the following comparison information:
the data sequence numbers of the frames of said first stream already received from said first sub-stream by the first tunnel end-point and not yet acknowledged by a receiver device;
last acknowledgment sequence number for said given stream received by said first tunnel end-point;
number of times said last acknowledgment sequence number for said given stream has been received by said first tunnel end-point;
determining said first pieces of transmission issue information, on the basis of the data sequence number read or the acknowledgment sequence number read and said obtained comparison information.

4. Method according to claim 1, wherein, if said given stream is a first stream coming out of said first tunnel end-point and entering said tunnel, said first partial determining step comprises the following steps, performed in the event of a detection, from an acknowledgment sequence number received for said given stream, of a transmission issue located in the tunnel:
determining a type, reliable or non-reliable, of a channel via which the data, to which said acknowledgment sequence number corresponds, has been transmitted on the tunnel;
if said channel is of a reliable type, indicating that the nature of the transmission issue is “out-of-sequence frame transmission”;
if said channel is of a non-reliable type, indicating that the nature of the transmission issue is “loss of frame”.

5. Method according to claim 1, wherein, if said given stream is a second stream coming out of said tunnel and entering said first tunnel end-point, said first partial determining step comprises the following steps, for at least one frame transporting data of said given stream or an acknowledgment of data of said given stream:
reading a data sequence number or of an acknowledgment sequence number contained in said frame;
obtaining the following pieces of comparison information;
the data sequence numbers of the frames of said second stream already received from the tunnel by the first tunnel end-point and not yet acknowledged by a reception device;
last acknowledgment sequence number for said given stream received by said first tunnel end-point;
number of times said last acknowledgment sequence number for said given stream has been received by said first tunnel endpoint;
determining said first pieces of transmission issue information, from the data sequence number read or from said acknowledgment sequence number read and said pieces of comparison information obtained.

6. Method according to claim 1, wherein, if said given stream is a second stream coming out of said tunnel and entering said first tunnel end-point, said first partial determining step comprises the following steps, performed if an acknowledgment sequence number received for said given stream has already been received from the first subnetwork by the first tunnel end-point and if the data required by a receiver having sent said acknowledgment sequence number has not yet been received by the first tunnel end-point:
indicating that the transmission issue is located in the tunnel or the second sub-network;
transmitting to said second tunnel end-point a control message (COM2) requesting said second tunnel end-point to temporarily stop a mechanism of dynamic selection, for said given stream, of an effective channel amongst several transmission channels of said tunnel.

7. Method according to claim 1, wherein said steps a) to c) are performed for each frame transporting data of said given stream or an acknowledgment of data of said given stream.

8. Method according to claim 1, wherein said first and second pieces of transmission issue information comprise:
three pieces of information on nature of a transmission issue, pertaining respectively to the three following natures: “loss of frame”, “expiry of a transmission timer” and “out-of-sequence frame transmission”;
three pieces of information on the location of a transmission issue, pertaining respectively to the following three locations: “on the first sub-network”, “on the second sub-network” and “on the tunnel”;
a piece of information on retransmission indicating that the data transmitted with said piece of retransmission information has already been transmitted via the tunnel.

9. Method according to claim 1, wherein said step of managing said transmission enhancement mechanisms comprises the following steps:
if said transmission issue for said given stream is totally determined and not yet processed, incrementing a counter associated with the type of said transmission issue for said given stream;
if said counter is higher than a predetermined threshold, selecting a mechanism to enhance data stream transmission;
applying the selected enhance mechanism to said given stream.

10. Method according to claim 9, wherein said step of selecting a mechanism to enhance the data stream transmission is performed as a function of the nature and location of said transmission issue and as a function of the incoming or outgoing character of said given stream relatively to the tunnel.

11. Method according to claim 10, wherein said selecting step of selecting a mechanism to enhance data stream transmission is such that:
a first enhancement mechanism, enabling the storage in a local buffer memory of the frames received by the first tunnel end-point and the retransmission of these frames when a loss is detected on the first sub-network, is selected if the nature of the transmission issue is a “loss of frames” located in the first sub-network and if said given stream is a stream going out of said tunnel;
a second enhancement mechanism, used to delay the transmission to the sender device of acknowledgment frames received by the first tunnel end-point and coming from the first sub-network, is selected if the nature of the transmission issue is an “out-of-sequence frame transmission” located in the tunnel and if said given stream is a stream entering said tunnel; and
a third enhancement mechanism to store the frames and if necessary re-order them before retransmitting them on the tunnel to the second tunnel end-point, is selected if the nature of the transmission issue is a “an out-of-sequence frame transmission” located in the first sub-network and if said given stream is a stream entering said tunnel.

12. Storage medium, readable by a computer, storing a set of instructions that can be executed by said computer to implement a method for managing mechanisms enhancing data stream transmission via a tunnel, the transmission of each stream being performed according to a frame transport protocol with acknowledgment, said tunnel being implemented between a first and a second tunnel end-point connected respectively to a first and a second sub-network, each stream being transmitted from a sender device to a receiver device via said tunnel, one device among said sender device and said receiver device being connected to the first sub-network and the other being connected to the second sub-network,
wherein said set of instructions performs the following steps, for a given stream, when it is executed by said first tunnel end-point:
a) first partial determining step of determining a nature and a location of an issue of transmission for said given stream, enabling to obtain first pieces of transmission issue information by analysis of said given stream;
b) a receiving step of receiving, from said second tunnel end-point, second pieces of transmission issue information resulting from the execution of a second partial determining step of determining said transmission issue performed by said second tunnel end-point;
c) a managing step of managing said transmission enhancement mechanisms, as a function of said first and second pieces of transmission issue information.

13. First tunnel end-point for managing mechanisms to enhance data stream transmission on a tunnel supported by a main communications network, the transmission of each stream being performed according to a frame transport protocol with acknowledgment, said tunnel being implemented between a first and a second tunnel end-point connected respectively to a first and a second sub-network, each stream being transmitted from a sender device to a receiver device via said tunnel, one device among said sender device and said receiver device being connected to the first sub-network and the other being connected to the second sub-network, wherein said first tunnel end-point comprises:
means for partial determining, enabling the performance of a first partial determining of a nature and a location of a transmission issue for said given stream, and enabling the obtaining of first pieces of transmission issue information by analysis of said given stream;
means for receiving, from said second tunnel end-point, second pieces of transmission issue information and resulting from the execution of a second partial determining of said transmission issue performed by said second tunnel end-point;
means for managing said transmission enhancement mechanisms, as a function of said first and second pieces of transmission issue information.

14. First tunnel end-point according to claim 13, wherein it further comprises:
means for transmitting said first pieces of transmission issue information to said second tunnel end-point.

15. First tunnel end-point according to claim 13, wherein said means for partial determining comprise the following means, activated for at least one frame transporting data of said given stream or an acknowledgment of data of said given stream, if said given stream is a first stream coning out of said tunnel end-point and entering said tunnel:
means for reading a data sequence number or an acknowledgment sequence number contained in said frame;
means for obtaining the following comparison information:
the data sequence numbers of the frames of said first stream already received from said first sub-stream by the first tunnel end-point and not yet acknowledged by a receiver device;
last acknowledgment sequence number for said given stream received by said first tunnel end-point;
number of times said last acknowledgment sequence number for said given stream has been received by said first tunnel end-point;
means for determining said first pieces of transmission issue information, on the basis of the data sequence number read or the acknowledgment sequence number read and said obtained comparison information.

16. First tunnel end-point according to claim 13, wherein said means for partial determining comprise the following means, activated if said given stream is a first stream coming out of said first tunnel end-point and entering said tunnel, and in the event of a detection, from an acknowledgment sequence number received for said given stream, of a transmission issue located in the tunnel:
means for determining a type, reliable or non-reliable, of a channel via which the data, to which said acknowledgment sequence number corresponds, has been transmitted on the tunnel;
means, activated if said channel is of a reliable type, for indicating that the nature of the transmission issue is “out-of-sequence frame transmission”;
means, activated if said channel is of a non-reliable type, for indicating that the nature of the transmission issue is “loss of frame,”.

17. First tunnel end-point according to claim 13, wherein said means for partial determining comprise the following means, activated if said given stream is a second stream coming out of said tunnel and entering said first tunnel end-point, if an acknowledgment sequence number received for said given stream has already been received from the first sub-network by the first tunnel end-point and if the data required by a receiver having sent said acknowledgment sequence number has not yet been received by the first tunnel end-point:
means for indicating that the transmission issue is located in the tunnel or the second sub-network;
means for transmitting to the second tunnel end-point a control message requesting the second tunnel end-point to temporarily stop a mechanism of dynamic selection, for said given stream, of an effective channel amongst several transmission channels of said tunnel.

18. First tunnel end-point according to claim 13, wherein said means for managing said transmission enhancement mechanisms comprise:
means, activated if said transmission issue for said given stream is totally determined and not yet processed, for incrementing a counter associated with the type of said transmission issue for said given stream;
means for comparing an output value of said counter with a pre-determined threshold,
means, activated if said counter comparison means indicate that the output value of said counter is higher than a pre-determined threshold, for selecting a mechanism to enhance data stream transmission;
means for applying selected enhancement mechanism to said given stream.

19. First tunnel end-point according to claim 18, wherein said means for selecting a mechanism to enhance the data stream transmission take account of the nature and location of said transmission issue and the incoming or outgoing character of said given stream relatively to the tunnel.

20. First tunnel end-point according to claim 19, wherein said means for selecting a mechanism to enhance data stream transmission are such that:
a first enhancement mechanism enabling the storage in a local buffer memory of the frames received by the first tunnel end-point and the retransmission of these frames when a loss is detected on the first sub-network, is selected if the nature of the transmission issue is a “loss of frames” located in the first sub-network and if said given stream is a stream going out of said tunnel;
a second enhancement mechanism to delay the transmission to the sender device of acknowledgment frames received by the first tunnel end-point and coming from the first sub-network is selected if the nature of the transmission issue is an “out-of-sequence frame transmission” located in the tunnel and if said given stream is a stream entering said tunnel; and
a third enhancement mechanist to store the frames and if necessary re-order them before retransmitting them on the tunnel to the second tunnel end-point, is selected if the nature of the transmission issue is a transmission of an “out-of-sequence frame transmission” located in the first sub-network and if said given stream is a stream entering said tunnel.
